(19) United States
(12) Patent Application Publication
(10) Pub. No.: US 2015/0212988 A1
(43) Pub. Date: Jul. 30, 2015

(54) INFORMATION DISPLAY METHOD AND PROGRAM

(71) Applicant: Panasonic Intellectual Property Corporation of America, Torrance, CA (US)

(72) Inventors: Kento Ogawa, Osaka (JP); Keiji Icho, Osaka (JP)

(21) Appl. No.: 14/421,017

(22) PCT Filed: Jun. 3, 2014
(86) PCT No.: PCT/JP2014/002946

§ 371 Date: Feb. 11, 2015

(30) Foreign Application Priority Data
Jun. 4, 2013 (JP) 2013-117913

(51) Int. Cl. G06F 17/22; G06F 17/30

(52) U.S. Cl. CPC G06F 17/2247; G06F 17/30424

(57) ABSTRACT

A query input by a user is acquired, the structure of a target Web page is analyzed, a query related region relating to the query is determined from the target Web page, the query related region is adjusted on the basis of rectangle information indicating the size of the rectangle of a terminal screen and a query Web page is created, and the created query Web page is transmitted to a terminal device.

### TECHNICAL FIELD

The present disclosure relates to a technique for displaying a Web page on a terminal device.

### BACKGROUND ART

In recent years, the opportunities have been increasing for users to browse information of Web sites with portable terminals such as smartphones and tablet terminals while the amount of information in Web pages in Web sites for PC have been increasing. However, the size of the display screen varies among the portable terminals, and the problem is that a Web page designed for a PC is difficult for the user to see and handle on a portable terminal having a small display size. In this context, a technique has been suggested by which a Web page is divided on the basis of division positions designated by the creator of a Web site or a predetermined division size that has been defined in advance, and the divided Web page is then displayed on a portable terminal (see, for example, Patent Literature 1 and Patent Literature 2).

### CITATION LIST

### Patent Literature

Patent Literature 1: Japanese Unexamined Patent Publication No. 2008-123419
Patent Literature 2: Japanese Unexamined Patent Publication No. 2001-109655

### SUMMARY OF INVENTION

However, the above-described conventional technique needs to be further improved.

In order to resolve the problems inherent to the related art, an information display method according to one aspect of the present disclosure, which is

an information display method for an information display system that displays a Web page on a terminal device, includes:

a query information acquisition step for acquiring query information including a query input by a user, and rectangle information indicating a size of a rectangle of a terminal screen of the terminal device for displaying the Web page;

a Web page structure analysis step for analyzing a structure of a target Web page which is a display target of the terminal device;

a query related region determination step for determining a query related region which relates to the query information in the target Web page on the basis of the query information and an analysis result for the target Web page;

a Web page creation step for adjusting the query related region on the basis of the rectangle information, and creating a query Web page by using the adjusted query related region; and

a transmission step for transmitting the query Web page to the terminal device via a network.

### BRIEF DESCRIPTION OF DRAWINGS

FIG. 1 is a block diagram illustrating the configuration of a system including the information display control device of the present disclosure.

FIG. 2 illustrates an example of a query information table in the present disclosure.

FIG. 3 illustrates an example of a constituent element text information table in the target Web page with a target Web page ID “W-00001” in the present disclosure.

FIG. 4 illustrates a contents example of text information of the constituent element with a constituent element ID “C-002” in the present disclosure.

FIG. 5 illustrates a contents example of style information of the constituent element with a constituent element ID “C-002” in the present disclosure.

FIG. 6 illustrates an example of a query related region information table in the target Web page with a target Web page ID “W-00001” in the present disclosure.

FIG. 7 is a summary of information display control processing in the target Web page with a target Web page ID “W-00001” in the present disclosure.

FIG. 8 is a flowchart illustrating the flow of information display control processing in the present disclosure.

FIG. 9 is a flowchart illustrating the flow of the first query Web page creation processing in the present disclosure.

FIG. 10 illustrates a contents example of text information of a query Web page in the target Web page with a target Web page ID “W-00001” in the present disclosure.

FIG. 11 illustrates a contents example of style information of a query Web page in the target Web page with a target Web page ID “W-00001” in the present disclosure.

FIG. 12 is a flowchart illustrating the flow of the second query Web page creation processing in the present disclosure.

FIG. 13 illustrates an example in which the displays describing the positions and sizes of query related regions in the target Web page with a target Web page ID “W-00001” in the present disclosure are combined together in the query Web page.

FIG. 14 illustrates an example in which the display describing the position and size of a query related region in a static image in the present disclosure is combined with a static image.

FIG. 15 illustrates an example in which the display describing the reproduction start and end positions and the length of a query related region in a dynamic image in the present disclosure is combined with a dynamic image.

FIG. 16 illustrates a display example in which a query Web page is displayed in a plurality of rectangles.

FIG. 17 illustrates another display example in which a query Web page is displayed in a plurality of rectangles.

FIG. 18A is an overall picture of the information display system in the present disclosure.

FIG. 18B is an overall picture of the information display system in the present disclosure.

FIG. 18C is an overall picture of the information display system in the present disclosure.

FIG. 19 illustrates Type 1 (own data center type) of services in the present disclosure.

FIG. 20 illustrates Type 2 (IaaS usage type) of services in the present disclosure.

FIG. 21 illustrates Type 3 (PaaS usage type) of services in the present disclosure.

FIG. 22 illustrates Type 4 (SaaS usage type) of services in the present disclosure.

### DESCRIPTION OF EMBODIMENTS

(How an Embodiment of the Present Invention was Obtained)

As indicated hereinabove, the opportunities have been increasing for users to browse Web pages for PC on portable terminals such as smartphones and tablet terminals, but the problem is that a Web page designed for a PC is difficult for the user to see and handle on a portable terminal having a small display size. Accordingly, a technique has been suggested by which a Web page is divided on the basis of the division positions designated by the creator of a Web site or a predetermined division size that has been defined in advance, and the divided Web page is then displayed on a portable terminal. However, a problem associated with this conventional technique is that a method for dividing a Web page is determined regardless of the intention of the user, and therefore it is impossible to browse smoothly only the Web page information relating to the query input by the user.

Through a series of research and study, the inventors have found that it is possible to browse smoothly only the Web page information relating to the query input by the user by determining regions relating to a query in a Web page on the basis of the structure analysis result for the Web page and the query input by the user, create a Web page from the determined regions, and display the created Web page on a portable terminal. This finding led to the present disclosure.

(1) An information display method according to one aspect of the present disclosure is

an information display method for an information display system that displays a Web page on a terminal device, including:

a query information acquisition step for acquiring query information including a query input by a user, and rectangle information indicating a size of a rectangle of a terminal screen of the terminal device for displaying the Web page;

a Web page structure analysis step for analyzing a structure of a target Web page which is a display target of the terminal device;

a query related region determination step for determining a query related region which relates to the query information in the target Web page on the basis of the query information and an analysis result for the target Web page;

a Web page creation step for adjusting the query related region on the basis of the rectangle information, and creating a query Web page by using the adjusted query related region; and

a transmission step for transmitting the query Web page to the terminal device via a network.

In this case, the query related region relating to the query information including the query input by the user is determined in the target Web page which is the display target, the determined query related region is adjusted to conform to the rectangle of the terminal screen, and a query Web page is created and transmitted to the terminal device. Thus, the query Web page is created such as to conform to the rectangle of the terminal screen. As a result, the Web page created to conform to the usual personal computer can be displayed on a size suitable for a terminal device with a small screen size. Further, information which does not relate to the query input by the user is omitted in the query Web page. Therefore, only the information relating to the query input by the user himself can be smoothly browsed. Only the query input by the user may be included in the query information, and the query related information relating to the query may be included.

(2) In the aspect, the rectangle information may be information relating to a width and a height of a rectangle for displaying a Web page on the terminal screen.

(3) Further, in the aspect, the structure of the target Web page may include information relating to a size of the target Web page, information relating to constituent elements of the target Web page, and information relating to query information included in the constituent elements.

In this case, the information relating to the size of the target Web page, the information relating to constituent elements of the target Web page, and the information relating to query information included in the constituent elements are analyzed from the target Web page.

(4) Further, in the aspect, in the query related region determination step, the query information related region may be determined on the basis of at least one of information among information relating to the number of types of query information included in the constituent elements of the target Web page, and information relating to an appearance position of the query information.

In this case, since the query related region is determined using the information relating to the number of types of query information or the information relating to the appearance position of the query, all or some of the constituent elements of the target Web page including the query information can be determined as the query related region.

(5) Further, in the aspect, in the Web page creation step, a display width and a display height of the constituent elements in the query Web page may be determined using a ratio of a width of the rectangle to a maximum value of a width of a constituent element to which the query related region belongs in the target Web page.

In this case, the display width and display height of one or more of the constituent elements constituting the query Web page are determined using the ratio of the width of the rectangle to the maximum value of the width of the constituent element to which the query related region belongs. Therefore, when the query Web page is created by arranging the constituent elements in the vertical direction, the constituent elements can be displayed such that the width of each constituent element is fit into the width of the rectangle. Further, the surface area ratio of each constituent element of the query Web page is maintained to be the same as the surface area ratio of the target Web page. As a result, a query Web page causing no discomfort to the user can be presented.

(6) In the aspect, in the Web page creation step, a display order of the constituent elements on the query Web page may be determined on the basis of at least any one condition from among:

a first condition that the display order on the query Web page is decreased for a constituent element to which the query related region belongs and which has a larger display width and a smaller display height in the query Web page;

a second condition that the display order on the query Web page is decreased for a constituent element to which the query related region belongs and which has a smaller appearance order on the target Web page;

a third condition that the display order on the query Web page is determined according to a type of the constituent element to which the query related region belongs; and

a fourth condition that the display order on the query Web page is decreased for a constituent element to which the query related region belongs and which has a larger number of types of the query information.

When a first condition is used, the display order is decreased for a constituent element with a larger display width and a smaller display height. Therefore, for example, when the query Web page is created by arranging the constituent elements in the vertical direction, a maximum possible number of the constituent elements can be displayed in the rectangle of the terminal screen.

When a second condition is used, a constituent element with a smaller appearance order on the target Web page is preferentially displayed on the query Web page. Therefore, the display order of the constituent elements of the query Web page can be determined with consideration for the appearance order on the target Web page.

When a third condition is used, the display order of the constituent elements can be determined by an order preset with respect to the types (for example, text and images) to which the query related region belongs. Therefore, the display order of the constituent elements of the query Web page can be rapidly determined.

When a fourth condition is used, a constituent element including a larger volume of query information is preferentially displayed on the query Web page.

(7) Further, in the aspect, in the Web page creation step, a display position of the constituent elements in the query Web page may be calculated on the basis of the display order and display height of the constituent elements in the query Web page.

In this case, the display position of each constituent element in the query Web page is calculated using the display order and display height of the constituent element. Therefore, the query Web page is created by arranging the constituent elements in the vertical direction.

(8) Further, in the aspect, in the Web page creation step, style information that defines a display layout of the constituent elements of the target Web page may be processed on the basis of the display width and display height and the calculated display position of the constituent elements in the query Web page.

In this case, the style information of the target Web page is processed using the display width, display height, and display position of the constituent elements in the query Web page, and style information of the query Web page is created.

(9) Further, in the aspect, in the Web page creation step, the query Web page may be created by adjusting the query related region on the basis of the display order of the constituent elements on the query Web page, the processed style information, and predetermined HTML text information of the target Web page.

In this case, the query related region is adjusted using the display order of the constituent elements on the query Web page, the style information, and the predetermined HTML text information, and the query Web page is created.

(10) Further, in the aspect, in the Web page creation step, a display image indicating the position and size of the constituent elements of the query Web page in the target Web page may be created on the basis of the size of the target Web page and the display position, width, and height of the constituent elements of the query Web page in the target Web page.

In this case, the display image indicating the position and size of the constituent elements of the query Web page in the target Web page is created. Therefore, the user looking at the display image can rapidly recognize the location on the target Web page where the constituent elements of the query Web page are disposed.

(11) Further, in the aspect, in the Web page creation step, the display image may be combined together with the query Web page.

In this case, since the display image is displayed in combination with the query Web page, the user browsing the query Web page can recognize the location on the target Web page where the constituent elements of the query Web page are disposed.

(12) Further, in the aspect, in the Web page creation step, a display width and a display height of the constituent elements in the query Web page may be determined using a ratio of a height of the rectangle to a maximum value of the height of the constituent element to which the query related region belongs in the target Web page.

In this case, the display width and display height of the constituent elements in the query Web page are determined using the ratio of the height of the rectangle of the terminal screen to a maximum value of the height of the constituent element to which the query related region belongs in the target Web page. Therefore, when the query Web page is created by arranging the constituent elements in the transverse direction, the constituent elements can be displayed such that the height of each constituent element is fit into the height of the rectangle. Further, the surface area ratio of each constituent element of the query Web page is maintained to be the same as the surface area ratio of the target Web page. As a result, a query Web page causing no discomfort to the user can be presented.

(13) Further, in the aspect, in the Web page creation step, a display position of the constituent elements in the query Web page may be calculated on the basis of a display order and the display width of the constituent elements in the query Web page.

In this case, since the display position of each constituent element in the query Web page is calculated on the basis of the display order and display width of the constituent element, the query Web page is created by arranging the constituent elements in the transverse direction.

(14) Further, in the aspect, in the Web page creation step,

the display order of the constituent elements on the query Web page may be determined on the basis of, in addition to the first to fourth conditions, at least any one condition from among:

a fifth condition that the display order on the query Web page is decreased for a constituent element to which the query related region belongs and which has a smaller display width and a larger display height;

a sixth condition that the display order on the query Web page is determined according to a browsing history on a network of a constituent element to which the query related information belongs; and

a seventh condition that the display order on the query Web page is determined according to a browsing history of a user who has input the query of a constituent element to which the query related information belongs.

When the fifth condition is used, the display order is decreased for a constituent element with a smaller display width and a larger display height. Therefore, for example, when the query Web page is created by arranging the constituent elements in the transverse direction, a maximum possible number of the constituent elements can be displayed in the rectangle of the terminal screen.

When the sixth condition is used, a constituent element that is of interest to a large number of users on a network is preferentially displayed in the query Web page.

When the seventh condition is used, a constituent element which has not been browsed by a user is preferentially displayed in the query Web page.

(15) Further, in the aspect, in the Web page creation step, when a change in the size of the rectangle is detected, a size of the query Web page may be changed according to the size of the rectangle after the change.

In this case, where the size of the rectangle is changed, the size of the query Web page is changed according to the size of the rectangle after the change. Therefore, the stress-free browsing of the query Web page can be performed even when the user has adjusted the size of the rectangle to the desired size.

(16) Further, in the aspect, in the Web page creation step, the target Web page may be displayed on the terminal screen when an input selecting the display image is detected.

In this case, the user can browse the target Web page only by inputting the operation of selecting a display image. Therefore, the user can browse the target Web page by a simple operation when it is considered that the user wants to see the target Web page while browsing the query Web page.

The present disclosure will be explained hereinbelow with reference to the appended drawings. The disclosure explained hereinbelow illustrates a specific example of the present example. The numerical values, shapes, constituent elements, steps, and sequences of steps illustrated in the following disclosure are merely exemplary and are not intended to restrict the present invention. Further, random constituent elements will be described hereinbelow as constituent elements that are not described in independent claims, which represent the highest concept, among the constituent elements in the present disclosure. Contents described in the present disclosure can be combined together.

(Overall Picture of Provided Services)

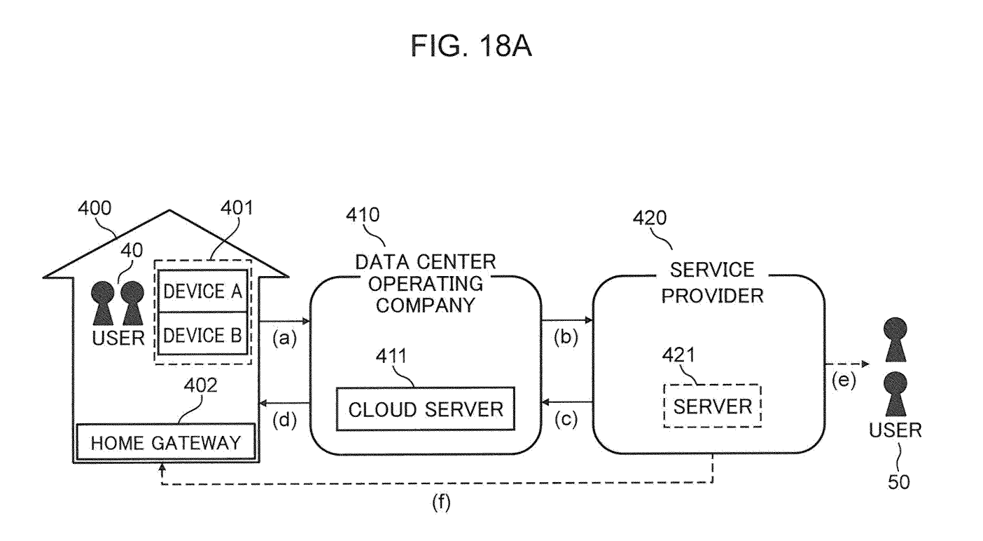

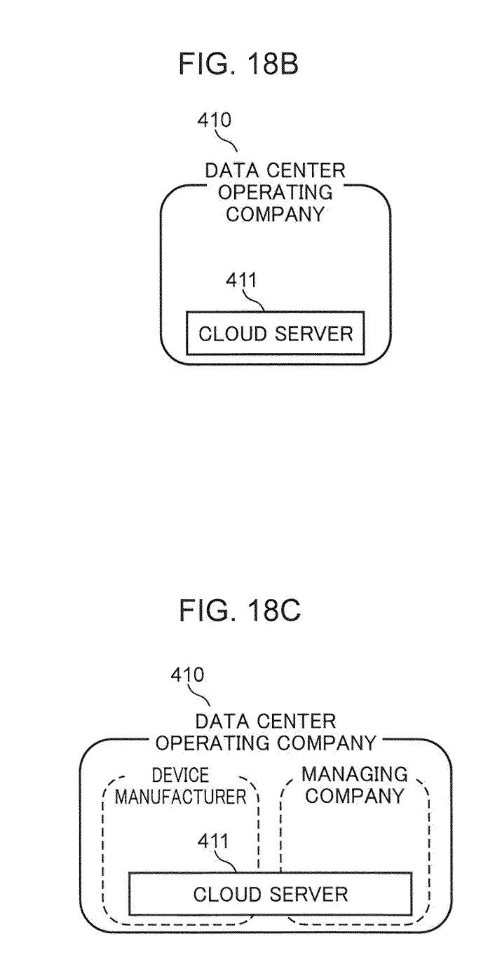

FIG. 18A illustrates the overall picture of the information display system in the present disclosure.

A group 400 is, for example, a company, an organization, or a house, and a scale thereof is not limited. A device A and a device B, which constitute a plurality of devices 401, and a home gateway 402 are present in the group 400. The plurality of devices 401 includes devices connectable to the Internet (for example, smartphones, PC, TV, etc.) and devices that cannot be by themselves connected to the Internet (for example, lighting, washing machines, refrigerators, etc.). There may also be devices that cannot be by themselves connected to the Internet, but can be connected to the Internet via the home gateway 402. A user 40 using the plurality of devices 401 is also included in the group 400.

A cloud server 411 is present in a data center operating company 410. The cloud server 411, as referred to herein, is a virtual server linked to various devices via the Internet. The cloud server 411 mainly manages large-volume data (big data) that are difficult to handle with the usual database management tools. The data center operating company 410 performs data management, management of the cloud server 411, and operation of the data center where the management is performed. The tasks performed by the data center operating company 410 are described hereinbelow in greater detail. The data center operating company 410 is not limited to a company that performs only data management and operation of the cloud server 411. For example, when a device manufacturer that develops and manufactures one device from among the plurality of devices 101 performs also the data management or the management of the cloud server 411, the device manufacturer corresponds to the data center operating company 410 (FIG. 18B). Further, the data center operating company 410 is not limited to one company. For example, when a device manufacturer and another management company share data management and operation of the cloud server 411 or jointly perform them, both companies or either of them corresponds to the data center operating company 410 (FIG. 18C).

The service provider 420 has a server 421. The server 421, as referred to herein, for example, includes a memory in an individual PC, regardless of the scale thereof. In some cases, the service provider does not have the server 421.

The home gateway 402 is not a mandatory component of the service. For example, when the cloud server 411 performs the entire data management, the home gateway 402 is not required. Further, in some cases, there are no devices that cannot be by themselves connected to the Internet, as when all of the devices in the house are connected to the Internet.

The flow of information in the service is explained below.

Initially, the device A or the device B of the group 400 transmits log information to the cloud server 411 of the data center operating company 410. The cloud server 411 collects the log information of the device A or device B (FIG. 18A(a)). In this case, the log information is, for example, information indicating the operation state or operation date and time of the plurality of devices 401. For example, the viewing history of a television, recording schedule information of a recorder, operation date/time and amount of washing in the washing machine, opening/closing date and time and number of opening/closing operation of a refrigerator correspond to the log information. However, those types of information are not limiting, and all types of information that can be acquired from any of the devices 401 correspond to the log information. The log information can be directly provided to the cloud server 411 from the plurality of devices 401 themselves via the Internet. The log information may be also temporarily collected from the plurality of device 401 in the home gateway 401 and then provided from the home gateway 402 to the cloud server 411.

The cloud server 411 of the data center operating company 410 then provides the collected log information to the service provider 420 in certain units. The certain unit, as referred to herein, may be a unit in which the information collected by the data center operating company 410 can be organized and provided to the service provider 420, or a unit requested by the service provider 420. Further, the log information is described to be provided in the certain units, but the unit does not need to be always constant and the volume of the provided information can be also changed according to the circumstances. If necessary, the log information is saved in the server 421 of the service provider 420 (FIG. 18A(b)). The service provider 420 organizes the information conforming to the service to be provided to the user and provides the organized information to the user. The user provided with the log information may be the user 40 using the plurality of devices 401 or may be an external user 50. A method for providing the service to the user may involve, for example, directly providing the service from the service provider 420 to the user 50 (FIG. 18A(e)). The service may be also provided to the user again via the cloud server 411 of the data center operating company 410 (FIGS. 18A(c) and 18A(d)). The cloud server 411 of the data center operating company 410 may also organize the log information to the information conforming to the service to be provided to the user and provide the organized information to the service provider 420.

The user 40 and the user 50 may be the same or separate.

### EMBODIMENT

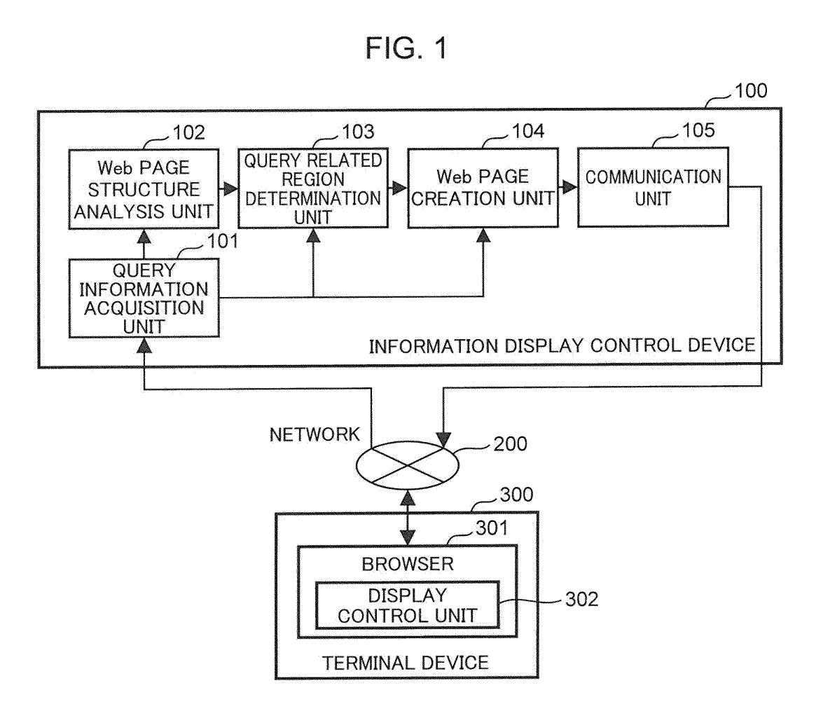

FIG. 1 is a block diagram illustrating the configuration of the information display system including the information display control device of the present disclosure. The information display control system depicted in FIG. 1 includes the information display control device 100 and a terminal device 300. The information display control device 100 and the terminal device 300 are connected to each other via a network 200.

The information display control device 100 is a Web server constituted, for example, by an enterprise-oriented computer (work station).

The terminal device 300 is, for example, an electric device suitable for Web page browsing, such as a personal computer, a video recorder, a BD recorder, a home server, a television, a set-top box, a car navigation system, a digital photo-frame, a digital stereo camera, a music player, a cellular phone, a smartphone, and a tablet terminal.

For example, the Internet can be used as the network 200.

The formation of the terminal device 300 is described below. The terminal device 300 includes a browser 301. The browser 301, as referred to herein, indicates an application in general that has a function enabling the browsing of a Web page, for example, a browser application or an application with a browser browsing function installed therein. The user can input a scroll operation, or an enlargement and reduction operation through the browser 301 and browse a Web page.

The browser 301 includes a display control unit 302. The display control unit 302 interprets the source code of the Web page transmitted from the information display control device 100 and displays the interpreted code on a display. In this case, the display may be provided at the terminal device 300 or outside the terminal device 300.

The configuration of the information display control device 100 is described below. The information display control device 100 includes a query information acquisition unit 101, a Web page structure analysis unit 102, a query related region determination unit 103, a Web page creation unit 104, and a communication unit 105.

The query information acquisition unit 101 detects the query input from the browser 301 via the network 200. Then, the query information acquisition unit 101 acquires the detected query, the query related information which is information relating to the input query, and rectangle information indicating the width and height of the terminal screen, and manages the acquired information as query information. Then, query information acquisition unit 101 detects the input of Web page information designating the Web page input from the browser 301. The query information acquisition unit 101 then acquires from the Web server and manages the Web page indicated by the input Web page information. Alternatively, the query information acquisition unit 101 acquires from the Web server and manages the Web page relating to the input query.

The query, as referred to herein, is for example, a keyword input by the user into the search engine displayed by the browser 301. In the explanation below, “BFD-PA600e” indicating the product number of a certain electric device or “LED lamp produced by OOOO Company.” indicating the product name of an electric device are presented, by way of example, as keywords. Further, the Web page information, as referred to herein, corresponds, for example, to an URL (Uniform Resource Locator) input into the browser 301 by the user. In the explanation below, “http://beautypro.com/facecare” is presented, by way of example, as the URL. The terminal screen is provided with a rectangle which is a display region of the Web page. The rectangle width, as referred to herein, indicates the length of one side in the transverse direction of the rectangle, and the rectangle height indicates the length of one side in the vertical direction of the rectangle.

Examples of methods for inputting the query or Web page information include the following methods (1) to (5). (1) Information is directly input to the terminal device 300 by using a keyboard, a touch panel, or a mouse. (2) Information is selected from a GUI (Graphical User Interface) indicated by the terminal device 300. (3) Information is input by reading, with a camera module incorporated in the terminal device 300, barcode information such as QR (Quick Response) code saved, for example, in the user's portable terminal. (4) A RFID tag with prerecorded information is read with a RFID reader incorporated in the terminal device 300 and information is input. (5) Information is input by voice recognition of the voice picked up by a microphone module incorporated in the terminal device 300, text recognition of the text input to the touch panel incorporated in the terminal device 300, or text recognition by processing an image captured by the camera incorporated in the terminal device 300.

The Web page structure analysis unit 102 analyzes the text information of a target Web page that is acquired by the query information acquisition unit 101 and assumed as a display target in the terminal device 300, extracts the width and height of the target Web page, the save URL of the text information and style information extracted for each constituent element constituting the target Web page, and the appearance order of the constituent elements, and manages the extracted types of the information. The Web page structure analysis unit 102 also calculates the number of queries and the number of types of query related information included for each constituent element and also the appearance position of the query and query related information by using the query and query related information managed by the query information acquisition unit 101, and manages the calculated types of information. In the present disclosure, the text information of the constituent elements of the Web page indicates information of HTML (Hyper Text Markup Language) used in the Web page production. The style information of the constituent elements of the Web page indicates CSS (Cascading Style Sheets) information used in the Web page production.

The query related region determination unit 103 determines the query related region, which is the region relating to a query, in the target Web page on the basis of the number of queries and number of types of query related information included for each constituent element of the Web page managed by the Web page structure analysis unit 102, and the appearance position of the query and query related information. The query related region determination unit 103 also manages the save URL of the text information and style information of the constituent element to which the determined query related information belongs, the appearance order of the constituent elements, the position, width, and height of the constituent elements, and the types of the constituent elements.

The Web page creation unit 104 adjusts the query related information on the basis of the rectangle information indicating the size of the rectangle of the terminal screen, and creates a query Web page by using the adjusted query related information. More specifically, the Web page creation unit 104 determines the display width and display height of each constituent element of the query Web page on the basis of the width of the rectangle of the terminal screen managed by the query information acquisition unit 101 and the maximum value of the width of the constituent element to which belongs the query related information managed by the query related region determination unit 103. The query Web page, as referred to herein, is a Web page constituted using all or some of the constituent elements to which belongs the query related region included in the target Web page, this Web page having a size suitable for displaying in the rectangle of the browser 301.

Further, the Web page creation unit 104 determines the display order of the constituent elements that are displayed on the query Web page on the basis of the determined display width and display height, the appearance order of the constituent elements, the type of the constituent elements, and the query and query related information included in the constituent elements. Further, the Web page creation unit 104 calculates the display positions of the constituent elements to be displayed on the query Web page on the basis of the determined display order of the constituent elements to be displayed on the query Web page, and the display height of the constituent elements. Then, the Web page creation unit 104 processes the style information of the constituent elements on the basis of the display width and display height of the constituent elements and the display position, and saves the processed style information in the save URL of the style information of the constituent element to which the query related region belongs.

The Web page creation unit 104 also creates the query Web page on the basis of the display order of the constituent elements, the text information and style information of the constituent element saved in the save URL of the text information and style information of the constituent element to which the query related region belongs, the predetermined HTML text information, and the text information of CSS.

The communication unit 105 transmits the query Web page created by the Web page creation unit 104 to the terminal device 300 via the network 200. As a result, the transmitted Web page is displayed by the browser 301. The rectangle of the terminal display is not limited to one rectangle, and a plurality of rectangles may be used.

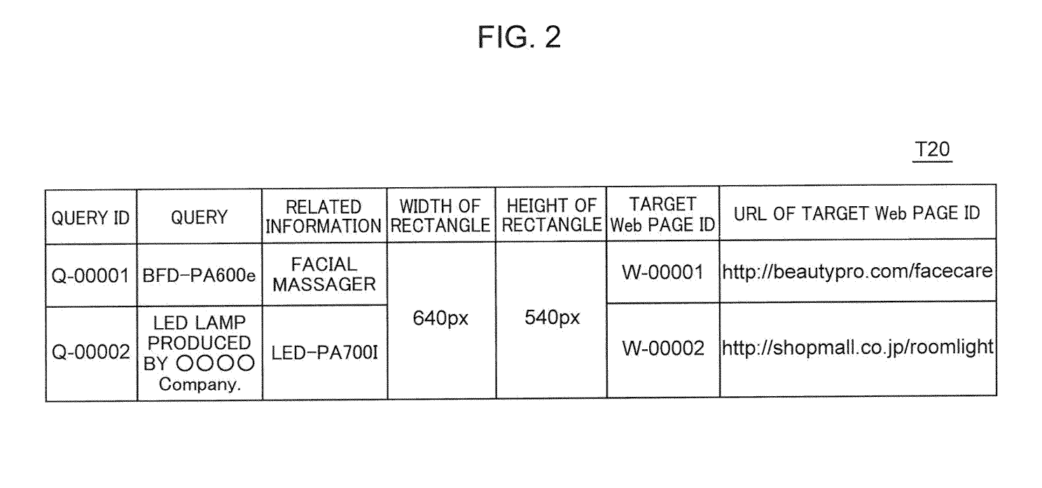

FIG. 2 illustrates an example of a query information table T20 in the present disclosure. The query information table T20 is generated and managed by the query information acquisition unit 101. The query information table T20 allocates one record for one query information, and the query information is managed. In the example depicted in FIG. 2, the query information table 120 includes “QUERY ID”, “QUERY”, “RELATED INFORMATION”, “WIDTH OF RECTANGLE”, “HEIGHT OF RECTANGLE”, “TARGET Web PAGE ID”, and “URL OF TARGET Web PAGE”. The “QUERY ID” indicates the identifier of the query input by the user. The “QUERY” indicates the input query itself. The “RELATED INFORMATION” indicates the related information of the input query. The “WIDTH OF RECTANGLE” indicates the width of the rectangle in the browser 301. The “HEIGHT OF RECTANGLE” indicates the height of the rectangle in the browser 301. The “TARGET Web PAGE ID” indicates the identifier of the target Web page. The “URL OF TARGET Web PAGE” indicates the saving location of the target Web page.

For example, in the query information of the query ID “Q-00001”, the query is “BFD-PA600e”, the query related information is a “FACIAL MASSAGER”, the width of the rectangle of the browser 301 is “640 px”, the height of the rectangle of the browser 301 is “540 px”, the target Web page ID is “W-00001”, and the URL of the target Web page is “http://beautypro.com/facecare”. The query related information as referred to herein indicates the synonym and equivalent word of the input query or a phrase that has been searched together with the input query by the search engine. The query related information is acquired using the vocabulary database of a thesaurus or the vocabulary data base of the search history of the search engine. Further, the width and height of the rectangle in the browser 301 may be calculated using a “width” parameter or a “height” parameter of the CSS of the target Web page, and may be acquired from the information indicating the size of the display region of the target Web page described in the program source of the application displaying the Web page, or the information indicating the screen size of the terminal device 300. Further, the number of each of the “RELATED INFORMATION”, “TARGET Web PAGE ID”, and “URL OF TARGET Web PAGE” in one query information with the same query ID is not limited to 1 and may be a multiple number.

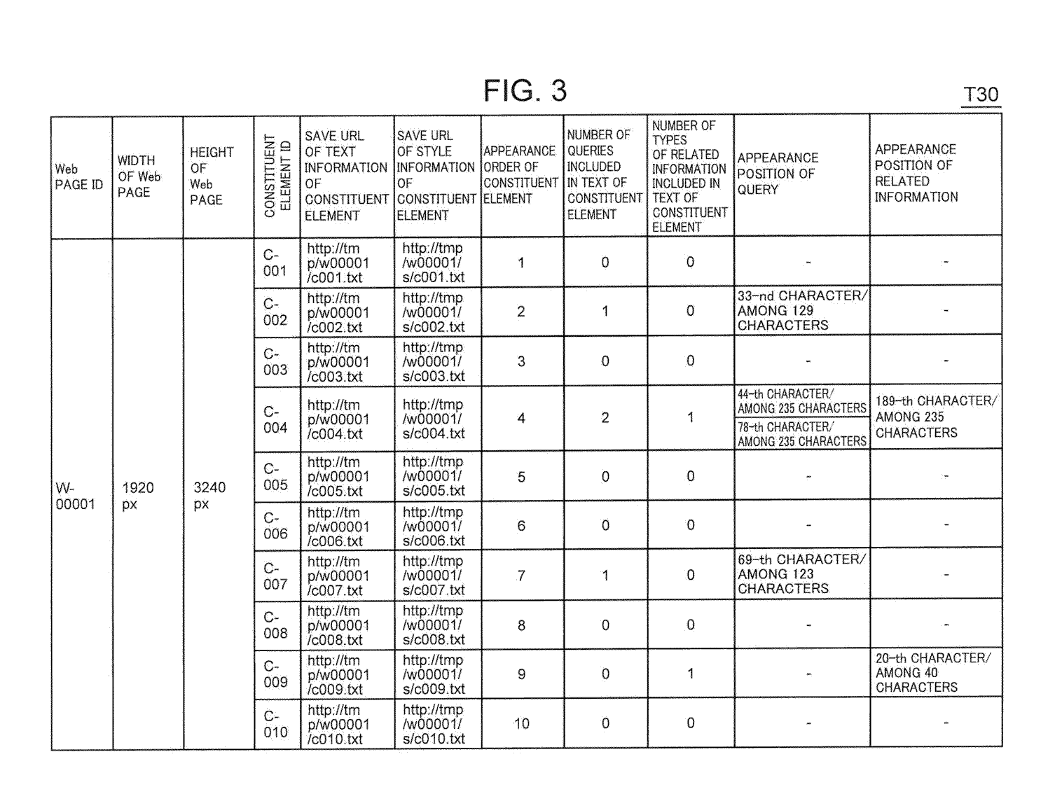

FIG. 3 illustrates an example of the constituent element text information table T30 of the target Web page with the target Web page ID “W-00001” in the present disclosure. The constituent element text information table T30 is generated and managed by the Web page structure analysis unit 102. In the example depicted in FIG. 3, the constituent element text information table T30 includes the “TARGET Web PAGE ID”, “WIDTH OF Web PAGE”, “HEIGHT OF Web PAGE”, “CONSTITUENT ELEMENT ID”, “SAVE URL OF TEXT INFORMATION OF CONSTITUENT ELEMENT”, “SAVE URL OF STYLE INFORMATION OF CONSTITUENT ELEMENT”, “APPEARANCE ORDER OF CONSTITUENT ELEMENT”, “NUMBER OF QUERIES INCLUDED IN TEXT OF CONSTITUENT ELEMENT”, “NUMBER OF TYPES OF RELATED INFORMATION INCLUDED IN TEXT OF CONSTITUENT ELEMENT”, “APPEARANCE POSITION OF QUERY”, and “APPEARANCE POSITION OF RELATED INFORMATION”.

The “TARGET Web PAGE ID” indicates the identifier of the target Web page. The “WIDTH OF Web PAGE” indicates the length of the target Web page in the transverse direction. The “HEIGHT OF Web PAGE” indicates the length of the target Web page in the vertical direction. The “CONSTITUENT ELEMENT ID” is the identifier of each constituent element constituting the target Web page. The “SAVE URL OF TEXT INFORMATION OF CONSTITUENT ELEMENT” is the URL indicating the saving location of the text information of each constituent element constituting the target Web page. The “APPEARANCE ORDER OF CONSTITUENT ELEMENT” indicates the order in which the constituent elements appear on the target Web page. For example, the appearance order is less for the constituent element disposed on the upper side in the target Web page. The “NUMBER OF QUERIES INCLUDED IN TEXT OF CONSTITUENT ELEMENT” indicates the number of times the query appears in each constituent element constituting the target Web page. The “NUMBER OF TYPES OF RELATED INFORMATION INCLUDED IN TEXT OF CONSTITUENT ELEMENT” indicates the number of time the query related information appears in each constituent element constituting the target Web page. The “APPEARANCE POSITION OF QUERY” indicates the position at which the query appears in each constituent element constituting the target Web page. The “APPEARANCE POSITION OF RELATED INFORMATION” indicates the position at which the query related information appears in each constituent element constituting the target Web page.

For example, the width of the target Web page with the target Web page ID “W-00001” is “1920 px”, the height of the target Web page is “3240 px”, and the target Web page includes ten constituent elements with constituent element IDs from “C-001” to “C-010”.

For example, for the constituent element with a constituent element ID “C-002”, from among the constituent elements of the target Web page, the “SAVE URL OF TEXT INFORMATION OF CONSTITUENT ELEMENT” is “http://tmp/w00001/c002.txt”, the “SAVE URL OF THE STYLE INFORMATION OF CONSTITUENT ELEMENT” is “http://tmp/w00001/s/c002.txt”, the “APPEARANCE ORDER OF CONSTITUENT ELEMENT” is “2”, the number of queries “BFD-PA600e” included in the text of the constituent element is “1”, the number of related information “FACIAL MASSAGER” included in the text of the constituent element is “0”, the appearance position of the query “BFD-PA600e” in the text of the constituent element is the “33-rd character among a total of 129 characters”. Since the number of appearances of the query related information “FACIAL MASSAGER” in the constituent element with the constituent element ID “C-002”, is “0”, it is represented by “-”.

The width and height of the target Web page are calculated, for example, by using a “width” parameter, a “height” parameter, a “top” parameter”, and a “left” parameter of the CSS of the target Web page. More specifically, the Web page structure analysis unit 102 calculates the minimum rectangle including all of the constituent elements of the target Web page, and calculates the width and height of the rectangle as the width and height of the Web page.

As for the extraction of the constituent elements of the Web page, for example, the Web page structure analysis unit 102 extracts the region surrounded by the specific information (“div”, “form”, “table”, “img”, “video”, “section”, and “article”) of the HTML of the target Web page as a constituent element.

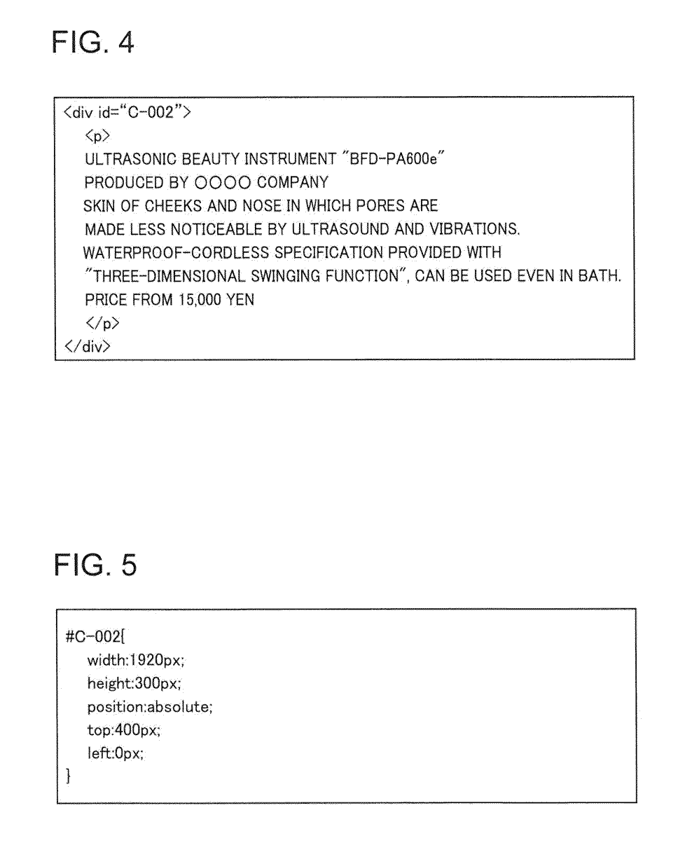

Further, the text information of the constituent element indicates the information on the constituent element included in HTML in the information constituting the target Web page. The title information of the constituent element indicates the information on the constituent element included in the CSS in the information constituting the target Web page. Specific examples thereof are depicted hereinbelow in FIGS. 4 and 5.

The appearance order of the constituent elements is determined, for example, by an algorithm according to which a constituent element described at a position closer to the text header of the HTML of the Web page has a smaller order rank. In FIG. 3, the constituent elements are described in the order from the text header of the HTML of the Web page with the target Web page ID “W-00001” from the constituent element with the constituent element ID “C-001” to the constituent element with the constituent element ID “C-010”.

Therefore, in the appearance order of the constituent elements, the appearance order from the constituent element with the constituent element ID “C-001” to the constituent element with the constituent element ID “C-010” is determined as from “1” to “10”, respectively, and registered in the constituent element text information table T30.

A method for determining the appearance order of the constituent elements is not particularly limited, and this order may be determined, for example, by using the “top” parameter or “left” parameter” which is the style information of the constituent elements described in the CSS of the target Web page. More specifically, the Web page structure analysis unit 102 sets a smaller appearance order for the constituent element with a smaller value of the “top” parameter and also a smaller value of the “left” parameter.

Further, the number of characters from the text header to the position where the query initially appears in the total number of characters of the text of the constituent element is used as the query appearance position. However, such a method is merely an example, and any method that determines the query position in the text of the constituent element may be used for representing the query appearance position. The same is true with respect to the appearance position of the query related information.

FIG. 4 illustrates a contents example of text information of the constituent element with the constituent element ID “C-002” in the present disclosure. The Web page structure analysis unit 102 manages a text file described in the HTML, as depicted in FIG. 4, as the text information of the constituent element for each constituent element of the target Web page. FIG. 4 represents the contents of the text information saved in “http://tmp/w00001/c002.txt”. The example depicted in FIG. 4 illustrates the text information of one constituent element extracted from the HTML of the target Web page with the Web page ID “W-00001” by using a “div” tag as an extraction condition.

FIG. 5 illustrates a contents example of style information of the constituent element with the constituent element ID “C-002” in the present disclosure. The Web page structure analysis unit 102 manages a text file described in the CSS, as depicted in FIG. 5, as the style information of the constituent element for each constituent element of the target Web page. FIG. 5 represents the contents of the style information saved in “http://tmp/w00001/s/c002.txt”. The example depicted in FIG. 5 illustrates the style information of the constituent element with the constituent element ID “C-002” in FIG. 4 that has been extracted from the CSS of the target Web page with the Web page ID “W-00001” by using a “C-002” tag as an extraction condition.

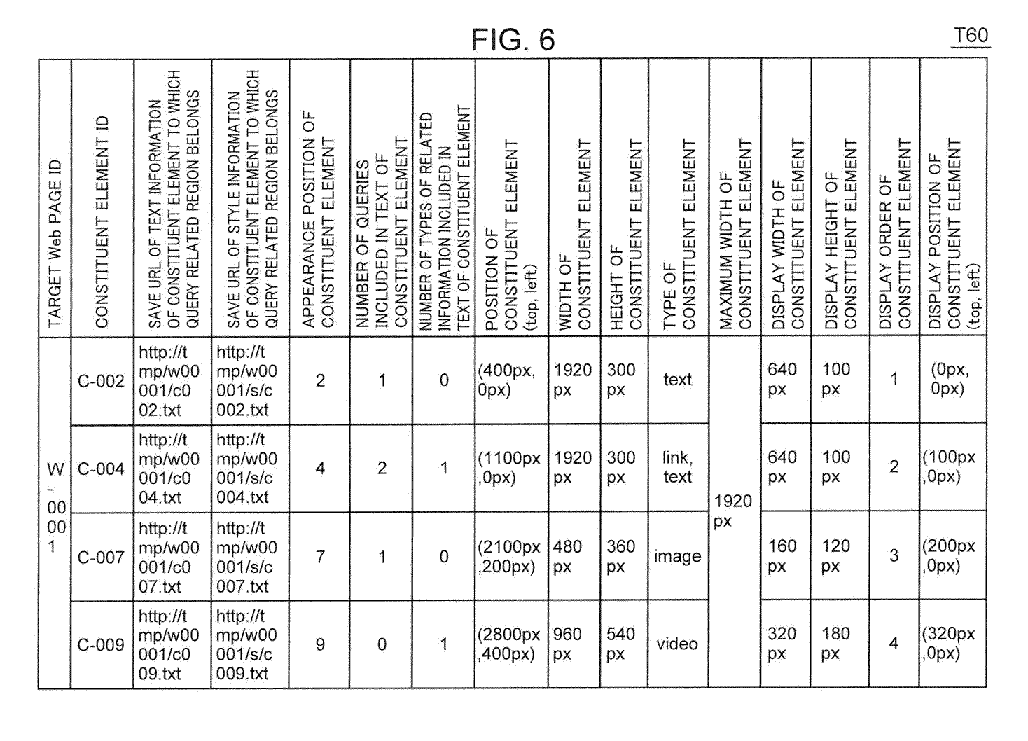

FIG. 6 illustrates an example of a query related region information table T60 in the target Web page with a target Web page ID “W-00001” in the present disclosure. The query related region information table T60 is generated and managed by the query related region determination unit 103.

In the example depicted in FIG. 6, the query related region information table T60 includes the “TARGET Web PAGE ID”, “CONSTITUENT ELEMENT ID”, “SAVE URL OF TEXT INFORMATION OF CONSTITUENT ELEMENT TO WHICH QUERY RELATED REGION BELONGS”, “SAVE URL OF STYLE INFORMATION OF CONSTITUENT ELEMENT TO WHICH QUERY RELATED REGION BELONGS”, “APPEARANCE ORDER OF CONSTITUENT ELEMENT”, “NUMBER OF QUERIES INCLUDED IN TEXT OF CONSTITUENT ELEMENT”, “NUMBER OF TYPES OF RELATED INFORMATION INCLUDED IN TEXT OF CONSTITUENT ELEMENT”, “POSITION (top, left) OF CONSTITUENT ELEMENT”, “WIDTH OF CONSTITUENT ELEMENT”, “HEIGHT OF CONSTITUENT ELEMENT”, “TYPE OF CONSTITUENT ELEMENT”, “MAXIMUM WIDTH OF CONSTITUENT ELEMENT”, “DISPLAY WIDTH OF CONSTITUENT ELEMENT”, “DISPLAY HEIGHT OF CONSTITUENT ELEMENT”, “DISPLAY ORDER OF CONSTITUENT ELEMENT”, and “DISPLAY POSITION (top, left) OF CONSTITUENT ELEMENT”.

In the example depicted in FIG. 6, the constituent elements to which the query related region belongs in the target Web page with the target Web page ID “W-00001” are four constituent elements with constituent element ID “C-002”, “C-004”, “C-007”, and “C-009”. The constituent element with the constituent element ID “C-002” is explained hereinbelow by way of example from among the constituent elements to this the query related information region belongs. For this constituent element, the “SAVE URL OF TEXT INFORMATION OF CONSTITUENT ELEMENT TO WHICH QUERY RELATED INFORMATION REGION BELONGS” is “http://tmp/w00001/c002.txt”, the “SAVE URL OF STYLE INFORMATION OF CONSTITUENT ELEMENT TO WHICH QUERY RELATED INFORMATION REGION BELONGS” is “http://tmp/w00001/s/c002.txt”, the “APPEARANCE ORDER OF CONSTITUENT ELEMENT” is “2”, the “NUMBER OF QUERIES INCLUDED IN TEXT OF CONSTITUENT ELEMENT” is “1”, and the “NUMBER OF TYPES OF RELATED INFORMATION INCLUDED IN TEXT OF CONSTITUENT ELEMENT” is “0”, Further, for this constituent element, the “POSITION OF CONSTITUENT ELEMENT” in the target Web page is “(top, left) (400 px, 0 px)”, that is, 400 px in the downward direction and 0 px in the rightward direction, with the upper left head portion of the target Web page being taken as a reference position. Further, for the constituent element, the “CONSTITUENT ELEMENT WIDTH” is “1920 px”, the “CONSTITUENT ELEMENT HEIGHT” is “300 px”, and the type of the constituent element is “text”.

The maximum value of the “CONSTITUENT ELEMENT WIDTH” among the constituent elements with the constituent element ID “C-002”, “C-004”, “C-007”, and “C-009” is “1920 px”. Therefore, “1920 px” is registered in the “MAXIMUM WIDTH OF CONSTITUENT ELEMENT”.

For the constituent element with the constituent element ID “C-002”, the “DISPLAY WIDTH OF CONSTITUENT ELEMENT” in the query Web page is “640 px”, the “DISPLAY HEIGHT OF CONSTITUENT ELEMENT” in the query Web page is “100 px”, the “DISPLAY ORDER OF CONSTITUENT ELEMENT” in the query Web page is “1”, and the “DISPLAY POSITION OF CONSTITUENT ELEMENT” in the query Web page is “(top, left) (0 px, 0 px)”. The “(top, left)=(0 px, 0 px)” indicates 0 px in the downward direction and 0 px in the rightward direction, with the upper left head portion of the Web page being taken as a reference position.

Here, the “SAVE URL OF TEXT INFORMATION OF CONSTITUENT ELEMENT TO WHICH QUERY RELATED REGION BELONGS”, “SAVE URL OF STYLE INFORMATION OF CONSTITUENT ELEMENT TO WHICH QUERY RELATED REGION BELONGS”, “APPEARANCE ORDER OF CONSTITUENT ELEMENT”, “NUMBER OF QUERIES INCLUDED IN TEXT OF CONSTITUENT ELEMENT”, and “NUMBER OF TYPES OF RELATED INFORMATION INCLUDED IN TEXT OF CONSTITUENT ELEMENT” are obtained by acquiring information from the “SAVE URL OF TEXT INFORMATION OF CONSTITUENT ELEMENT”, “SAVE URL OF STYLE INFORMATION OF CONSTITUENT ELEMENT”, “APPEARANCE ORDER OF CONSTITUENT ELEMENT”, “NUMBER OF QUERIES INCLUDED IN TEXT OF CONSTITUENT ELEMENT”, and “NUMBER OF TYPES OF RELATED INFORMATION INCLUDED IN TEXT OF CONSTITUENT ELEMENT” of the constituent element text information table T30 depicted in FIG. 3, and registering the acquired information in the query related region information table T60.

The “SAVE URL OF TEXT INFORMATION OF CONSTITUENT ELEMENT TO WHICH QUERY RELATED REGION BELONGS” is taken to have the same value as the “SAVE URL OF TEXT INFORMATION OF CONSTITUENT ELEMENT” of the constituent element text information table T30. However, this is only an example, and the query related region determination unit 103 may extract part of the text from the text information of the constituent element on the basis of the query related information, create anew the text file of the text information of the constituent element to which the query related region belongs, and save the created text file in a separate save URL.

For example, when the query or query related information is the front half of the constituent element, the query related region determination unit 103 may create anew the text file of the text information of the constituent element to which the query related region belongs on the basis of the text of the front half of the constituent element and save the created text file in a separate save URL.

Further, the “POSITION (top, left) OF CONSTITUENT ELEMENT” uses, for example, the value of the “top” parameter or “left” parameter, which is the style information of the constituent element described in the CSS of the target Web page. The “CONSTITUENT ELEMENT WIDTH” and “CONSTITUENT ELEMENT HEIGHT” use the values of the “width” parameter and “height” parameter, which are the style information of the constituent element described in the CSS of the target Web page. The “TYPE OF CONSTITUENT ELEMENT” is determined, for example, on the basis of tag information (“text”, “link”, “image”, “video”, “form”, and “table”) of each constituent element of the HTML of the target Web page.

More specifically, where text information described with tags such as “p”, “h”, “h1” to “h6”, or “li”, or text information described without a tag, is included in the constituent element extracted from the HTML of the target Web page by taking the “div” tag as an extraction condition, the “text” representing that the “TYPE OF CONSTITUENT ELEMENT” is a text is set. Further, where link information described by a tag such as “a href” is included in the constituent element, the “link” representing that the “TYPE OF CONSTITUENT ELEMENT” is a link is set. Where image information described by a tag such as “img” is included in the contents of the constituent element, the “image” representing that the “TYPE OF CONSTITUENT ELEMENT” is an image is set. Where video information described by a tag such as “video” is included in the constituent element, the “video” representing that the “TYPE OF CONSTITUENT ELEMENT” is video is set. Where input-transmission form information described by a tag such as “form” is included in the constituent element, the “form” representing that the “TYPE OF CONSTITUENT ELEMENT” is an input-transmission form is set. Where table information described by a tag such as “table” is included in the constituent element, the “table” representing that the “TYPE OF CONSTITUENT ELEMENT” is a table is set. Each constituent element may be of a plurality of types, as in the example of the constituent element with the constituent element ID “C-004”.

The “MAXIMUM WIDTH OF CONSTITUENT ELEMENT” is set as a maximum value of the “CONSTITUENT ELEMENT WIDTH” of the constituent elements with the constituent element ID “C-002”, “C-004”, “C-007”, and “C-009”.

The “DISPLAY WIDTH OF CONSTITUENT ELEMENT” and the “DISPLAY HEIGHT OF CONSTITUENT ELEMENT” in the query Web page are calculated by comparing the “MAXIMUM WIDTH OF CONSTITUENT ELEMENT” with the “WIDTH OF RECTANGLE” in the query information table T20 depicted in FIG. 2, calculating the ratio of the “WIDTH OF RECTANGLE” to the “MAXIMUM WIDTH OF CONSTITUENT ELEMENT”, and multiplying the width and height of each constituent element by the calculated ratio. For example, the “DISPLAY WIDTH OF CONSTITUENT ELEMENT” with the constituent element ID “C-002” is calculated in the following manner.

Initially, since the “MAXIMUM WIDTH OF CONSTITUENT ELEMENT” in the query related region information table T60 is “1920 px” and the “WIDTH OF RECTANGLE” in the query information table T20 is “640 px”, the ratio of the “WIDTH OF RECTANGLE” to the “MAXIMUM WIDTH OF CONSTITUENT ELEMENT” is calculated as “640/1920=1/3”. Then, “1920 px”, which is the “WIDTH OF CONSTITUENT ELEMENT” with the constituent element ID “C-002” is multiplied by “1/3” and “640 px” is obtained. The “640 px” is set as the “DISPLAY WIDTH OF CONSTITUENT ELEMENT”.

Likewise, “300 px” which is the “HEIGHT OF CONSTITUENT ELEMENT” with the constituent element ID “C-002” is multiplied by “1/3” and “100 px” is obtained. The “100 px” is then set as the “DISPLAY HEIGHT OF CONSTITUENT ELEMENT” in the query Web page. A method for determining the “DISPLAY ORDER OF CONSTITUENT ELEMENT” in the query Web page and a method for calculating the “DISPLAY POSITION OF CONSTITUENT ELEMENT” in the query Web page are described below in greater detail.

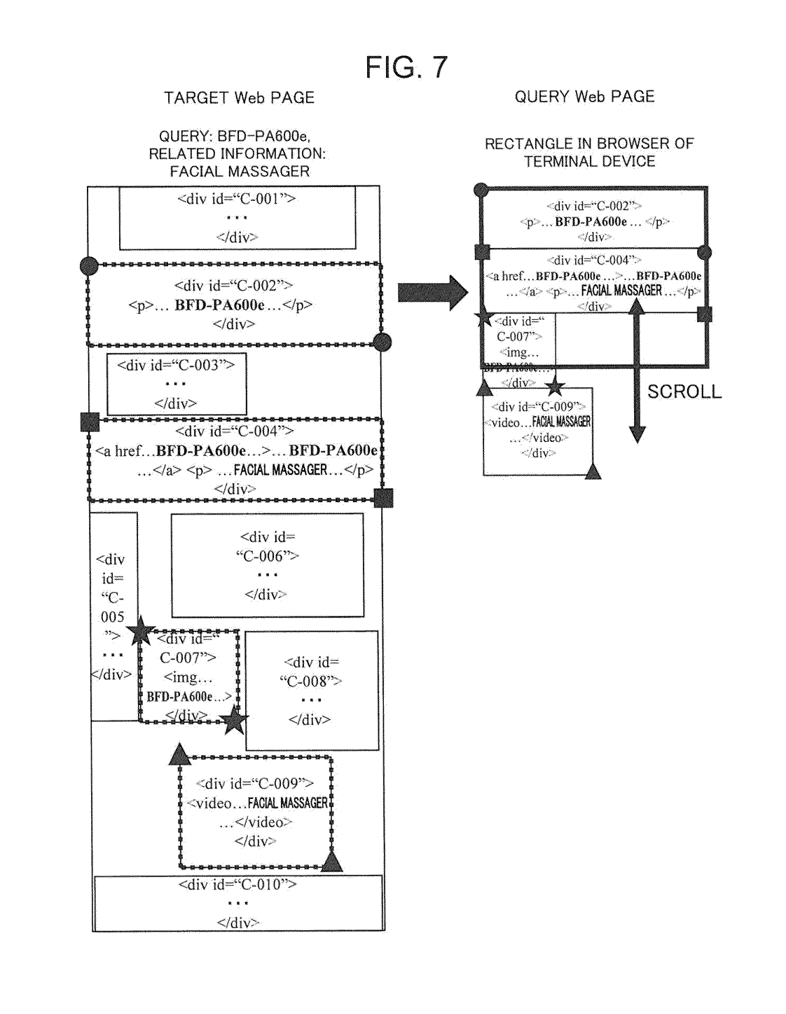

The information display control processing performed by the information display control device 100 of the present disclosure will be explained below with reference to FIGS. 7 to 15.

Initially, the summary of the information display control processing in the Web page with the target Web page ID “W-00001” in the present disclosure will be disclosed with reference to FIG. 7. The explanation is performed using the query information table T20 depicted in FIG. 2 and the constituent element text information table T30 depicted in FIG. 3. The explanation also assumes that the query input by the user is “BFD-PA600e”, and the query related information is the “FACIAL MASSAGER”. It is also assumed in the explanation that the target Web page is constituted by 10 constituent elements with the constituent element ID from “C-001” to “C-010”.

Those constituent elements are specifically the regions bounded by the “div” tags described in the HTML of the target Web page. First, constituent elements are extracted from the target Web page. Then, it is checked, for each constituent element, whether or not the query or query related information input from the user is included. The constituent element including the query or query related information input from the user is determined as the query related region.

The left drawing in FIG. 7 depicts schematically the constituent elements constituting the target Web page. In the example of the left drawing in FIG. 7, one region surrounded by a quadrangular frame indicates one constituent element. In the left drawing in FIG. 7, the query “BFD-PA600e” input from the user or the query related information “FACIAL MASSAGER” is included in the four constituent elements bounded by dot lines. Therefore, the regions of those four constituent elements are determined as the query related regions.

More specifically, the constituent element with round marks at the upper left apex and lower right apex includes the query “BFD-PA600e” and is, therefore, determined as the query related region. The constituent element with square marks at the upper left apex and lower right apex includes the query “BFD-PA600e” and the query related information “FACIAL MASSAGER” and is, therefore, also determined as the query related region. The constituent element with star marks at the upper left apex and lower right apex includes the query “BFD-PA600e” and is, therefore, determined as the query related region. The constituent element with triangular marks at the upper left apex and lower right apex includes the query related information “FACIAL MASSAGER” and is, therefore, determined as the query related region.

The width of each of the four query related regions is adjusted such that the maximum width of the query related regions and the width of the rectangle of the browser 301 match. The contents of the HTML and CSS of the query related regions is processed and the query Web page is created in order to display the query related region as the Web page.

The created query Web page is transmitted to the terminal device 300 and displayed on the browser 301. The right drawing in FIG. 7 depicts the constituent elements of the query Web page. The four constituent elements to which the query related regions belong are joined, and the query Web page constituted only by the constituent elements to which the query related regions belong can be browsed by the user through the browser 301. Further, the user inputs, as necessary a scroll operation, into the browser 301, thereby making it possible to scroll the query Web page.

In the right drawing in FIG. 7, a quadrangle indicated by a bold line depicts the rectangle of the browser 301. In this case, the query related regions which are the first and second from the top are fit into the rectangle, and the third query related region is partially fit into the rectangle. Therefore, the user can browse them at the same time. The query related region which is the fourth from the top is not fitted into the rectangle. Accordingly, the user displays the third query and fourth query related region inside the rectangle by inputting the scroll operation to the browser 301. As a result, the user can browse the third query and fourth query related region.

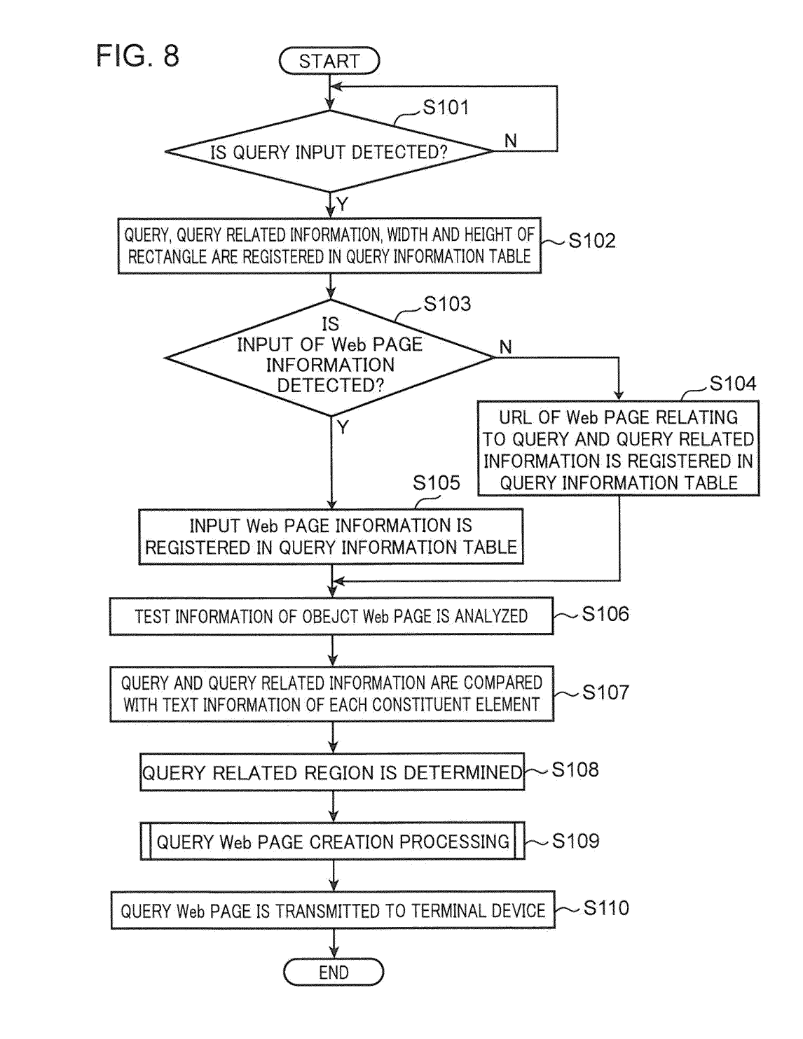

The flow of information display control processing of the information display control device 100 is explained hereinbelow using FIGS. 8 to 15.

Initially, the query information acquisition unit 101 receives, via the network 200, the query input by the user to the browser 301, and detects the query input (S101). Where the query input has not been detected (S101: N), the query information acquisition unit 101 again performs the processing of S101 for detecting a query input.

Meanwhile, where the query input has been detected (S101: Y), the query information acquisition unit 101 acquires the input query, query related information, and width and height of the rectangle of the browser 301, and registers the acquired information in the query information table T20 depicted in FIG. 2 (S102). For example, the user inputs “BFD-PA600e” as a query by using the touch panel, the browser 301 receives the input, and the query information acquisition unit 101 detects the query input. In this case, the query information acquisition unit 101 acquires, for example, a “FACIAL MASSAGER” as the query related information by using the vocabulary database of a thesaurus or a vocabulary database such as the search history of the search engine. Then, the query information acquisition unit 101 analyzes the program source of the browser 301 and acquires “640 px” and “540 px” as the width and height, respectively, of the rectangle of the browser 301. Then, the query information acquisition unit 101 assigns a query ID to those acquired types of information and registers them as query information in the query information table T20 depicted in FIG. 2.

Then, the query information acquisition unit 101 detects the input of the Web page information of the Web page which the user has input to the browser 301 and wishes to browse (S103). Where the input of the Web page information has not been detected (S103: N) within a predetermined period of time (for example, 10 sec), the query information acquisition unit 101 acquires the URL of the Web page relating to the query and query related information, sets the acquired URL as the URL of the target Web page, and registered the set URL in the query information table T20 (S104).

In this case, it is assumed that the application provider of the information display control device 100 has created in advance an URL database defining the URL of the Web page relating to the query and query related information. It is also assumed that in the URL database, “http://beautypro.com/facecare” has been defined as the URL of the Web page relating to the query information “BFD-PA600e” and query related information “FACIAL MASSAGER”. In this case, the query information acquisition unit 101 sets the Web page “http://beautypro.com/facecare” as the target Web page and registers the target Web page in association with the query ID in the query information table T20.

In the explanation herein, a method is described by which the presence of the input of Web page information is determined by the presence of the input within a predetermined period of time, but the present disclosure is not limited to this method. For example, a method may be used by which the determination is made on the basis of set information such as an input allowing setting of the Web page information of the Web page that the user wishes to browse. Further, a method using the URL database is used hereinabove as a method for acquiring the target Web page, but the present disclosure is not limited to this method. For example, a method may be used by which the URLs of the predetermined number of upper-level Web pages of the query search result in the search engine are acquired as the URL of the target Web page.

Meanwhile, where the input of the Web page information has been detected within the predetermined period of time (for example, 10 sec) (S103: Y), the query information acquisition unit 101 sets the URL indicated by the input Web page information as the URL of the target Web page and registers the set URL in the query information table T20 (S105).

For example, it is assumed that a plurality of Web pages relating to the query “BFD-PA600e” and query related information “FACIAL MASSAGER” input by the user have been obtained from the URL database or search results of the search engine. In this case, the query information acquisition unit 101 presents the plurality of Web pages to the user, selects among them the Web page (for example, the Web page “http://beautypro.com/facecare”) desired by the user, sets the URL to the selected Web page as the URL of the target Web page, and registers the set URL in association with the query ID in the query information table T20.

Then, the Web page structure analysis unit 102 analyzes the text information of the target Web page registered in the query information table T20 depicted in FIG. 2 and registers the width and height of the target Web page, the save URL of the text information and style information extracted for each constituent element of the target Web page, and the appearance order of the constituent elements in the constituent element text information table T30 depicted in FIG. 3 (S106).

More specifically, in the query information table T20 depicted in FIG. 2, the Web page with URL “http://beautypro.com/facecare” with the target Web page ID “W-00001” is assumed to be constituted by HTML and CSS. In this case, the Web page structure analysis unit 102 extracts as a constituent element the region bounded by the “div” tags described in the HTML of the Web page “http://beautypro.com/facecare” The extracted constituent element is registered in association with the target Web page ID in the constituent element text information table T30. For example, the Web page structure analysis unit 102 is assumed to extract ten regions bounded by the “div” tags described in the HTML of the Web page “http://beautypro.com/facecare”. In this case, the Web page structure analysis unit 102 allocates sequentially the identifiers from the constituent element ID “C-001” to the constituent element ID “C-010” to the ten extracted regions, and registers the resultant regions as ten constituent elements in association with the target Web page in the constituent element text information table T30.

Then, the Web page structure analysis unit 102 writes the text information described in HTML and the style information described in CSS to each text file in relation to the registered constituent elements, and saves the information in the predetermined URL. The Web page structure analysis unit 102 then registers each save URL as the “SAVE URL OF TEXT INFORMATION OF CONSTITUENT ELEMENT” and the “SAVE URL OF STYLE INFORMATION OF CONSTITUENT ELEMENT” in the constituent element text information table T30.

For example, “http://tmp/w00001/c002.txt” is registered in the “SAVE URL OF TEXT INFORMATION OF CONSTITUENT ELEMENT” of the constituent element ID “C-002” and “http://tmp/w00001/s/c002.txt” is registered in the “SAVE URL OF STYLE INFORMATION OF CONSTITUENT ELEMENT”. Specific examples of the contents of the files saved in each URL are depicted in FIG. 4 and FIG. 5, respectively.

When the constituent elements are extracted, the appearance order of the constituent elements is also determined. For example, the appearance order of the constituent elements is determined by an algorithm according to which a constituent element described at a position closer to the text header of the HTML of the Web page has a smaller order rank. For example, it is assumed that the constituent elements are successively described from the constituent element with the constituent element ID “C-001” to the constituent element with the constituent element Ii) “C-010” from the text header of the HTML of the Web page. In this case, the appearance order of the constituent elements is successively registered in the constituent element text information table T30 until the appearance order of the constituent element with the constituent element ID “C-001” reaches “I” and the appearance order of the very last constituent element with the constituent element ID “C-010” reaches “10”.

The width and height of the smallest rectangle which includes all of the constituent elements is used as the width and height of the target Web page from the values of “width” parameter, “height” parameter, “top” parameter, and “left” parameter included in the style information of each constituent element (from the constituent element ID “C-001” to the constituent element ID “C-010”) of the target Web page with “http://beautypro.com/facecare”. The width and height of this rectangle are registered as the width and height of the Web page in the constituent element text information table T30.

For example, the maximum value among the values obtained by adding the “width” parameter and “left” parameter for each constituent element is used as the width of the smallest rectangle including all of the constituent elements. Further, the maximum value among the values obtained by adding the “height” parameter and “top” parameter for each constituent element is used as the height of the smallest rectangle including all of the constituent elements.

This method for calculating the width of the target Web page and the height of the target Web page is not limiting. For example, a method may be used by which the predefined width and height values are described in the target Web page, and those values are acquired. FIG. 3, depicts the results obtained by calculating the width and height of the smallest rectangle including all of the constituent elements of “http://beautypro.com/facecare”. Thus, the width of the rectangle is “1920 px”, and the height of the rectangle is “3240 px”. Therefore, “1920 px” is registered as the “WIDTH OF Web PAGE”, and “3240 px” is registered as the “HEIGHT OF Web PAGE”.

Then, the Web page structure analysis unit 102 compares the query and query related information registered in the query information table T20 with the text information of each constituent element registered in the constituent element text information table T30, and registers the number of queries and the number of types of query related information included into each constituent element and the appearance positions of the query and query related information in the constituent element text information table T30 (S107).

More specifically, in the Web page “http://beautypro.com/facecare” with the target Web page ID “W-00001” the query “BFD-PA600e” and the query related information “FACIAL MASSAGER” are successively compared with the contents of the text file saved in the save URL of the text information of ten constituent elements from the constituent element ID “C-001” to the constituent element ID “C-010”. Then, the number of queries and the number of types of query related information included into each constituent element and the appearance positions of the query and query related information are extracted and registered in the constituent element text information table T30.

For example, in the text information of the constituent element with the constituent element ID “C-002”, which is depicted in FIG. 4, the query “BFD-PA600e” is included in the 33-rd character among a total of 129 characters, and the query related information “FACIAL MASSAGER” is not included. Therefore, the number of types of query information included in the constituent element with the constituent element ID “C-002” is “1”, the number of types of query related information is “0”, and the appearance position of query information is “33-rd CHARACTER/AMONG 129 CHARACTERS”. Further, since no query related information is present in the constituent element, “-” is set as the appearance position of query related information. Those types of information are registered in the constituent element text information table T30.

Then, the query related region determination unit 103 determines the query related region, which is the region relating to the input query in the target Web page, on the basis of the “NUMBER OF QUERIES INCLUDED IN TEXT OF CONSTITUENT ELEMENT”, “NUMBER OF TYPES OF RELATED INFORMATION INCLUDED IN TEXT OF QUERY OF CONSTITUENT ELEMENT”, and “APPEARANCE POSITION OF QUERY” which are registered in the constituent element text information table T30 depicted in FIG. 3 (S108). The query related region determination unit 103 then registers the save URL of the text information and style information, “APPEARANCE ORDER OF CONSTITUENT ELEMENT”, “NUMBER OF QUERIES INCLUDED IN TEXT OF CONSTITUENT ELEMENT”, “NUMBER OF TYPES OF RELATED INFORMATION INCLUDED IN TEXT OF CONSTITUENT ELEMENT”, “POSITION (top, left) OF CONSTITUENT ELEMENT”, “CONSTITUENT ELEMENT WIDTH”, “CONSTITUENT ELEMENT HEIGHT”, and “TYPE OF CONSTITUENT ELEMENT” in the query related region information table T60 depicted in FIG. 6 with respect to each determined query related region.

More specifically, initially, a constituent element for which the “NUMBER OF QUERIES INCLUDED IN TEXT OF CONSTITUENT ELEMENT” or the “NUMBER OF TYPES OF RELATED INFORMATION INCLUDED IN TEXT OF CONSTITUENT ELEMENT” is equal to or greater than 1 in the constituent element text information table T30 depicted in FIG. 3 is determined as the query related region. As depicted in FIG. 3, in the example of Web page “http://beautypro.com/facecare” with the target Web page ID “W-00001”, there are four constituent elements for which the “NUMBER OF QUERIES INCLUDED IN TEXT OF CONSTITUENT ELEMENT” or the “NUMBER OF TYPES OF RELATED INFORMATION INCLUDED IN TEXT OF CONSTITUENT ELEMENT” is equal to or greater than 1, namely, the constituent elements with the constituent element ID “C-002”, “C-004”, “C-007”, and “C-009”. Therefore, those constituent elements become the query related regions relating to the query “BFD-PA600e”.

The query related region may be also determined on the basis of the appearance position of the query and appearance position of the related information in addition to the “NUMBER OF QUERIES INCLUDED IN TEXT OF CONSTITUENT ELEMENT” or the “NUMBER OF TYPES OF RELATED INFORMATION INCLUDED IN TEXT OF CONSTITUENT ELEMENT”. For example, instead of determining all of the constituent elements that include the query and query related information as the query related region, it is possible to determine, as the query related region, a region from a predetermined number of characters (for example, 30 characters) before the appearance position of the query or query related information until a predetermined number of characters (for example, 30 characters) alter the appearance position of the query or query related information, among the constituent elements that include the query and query related information.

The HTML tag information such as “div” and “p” is necessarily included in the query related information, regardless of the appearance position of the query or query related information. For example, in the case of the constituent element with the constituent element ID “C-002”, which is depicted in FIG. 4, the region from 30 characters before the appearance position (33-rd character) of the query “BFD-PA600e” until 30 characters alter the appearance position is determined as the query related region. In this case, as will be described hereinbelow, the HTML tag information such as “div” or “p” is included in the query related region, regardless of the appearance position of the query. With such a determination method, the query related region is further narrowed down.

<div id = “C-002”>

<p>

Ultrasonic beauty instrument “BFD-PA600e” produced by OOOO
Company.
Skin of cheeks and nose in which pores are made less noticeable by

ultrasound and vibrations

</p>
</div>

A method for determining a query related region may also use an evaluation point of a constituent element calculated on the basis of the “NUMBER OF QUERIES INCLUDED IN TEXT OF CONSTITUENT ELEMENT” or the “NUMBER OF TYPES OF RELATED INFORMATION INCLUDED IN TEXT OF CONSTITUENT ELEMENT”. More specifically, an evaluation point is increased by “0.3” for one number in the “NUMBER OF QUERIES INCLUDED IN TEXT OF CONSTITUENT ELEMENT”, and an evaluation point is increased by “0.1” for one number in the NUMBER OF TYPES OF RELATED INFORMATION INCLUDED IN TEXT OF CONSTITUENT ELEMENT. The query related information is then determined using the constituent element with an evaluation point equal to or greater than “0.3”.

In the example, depicted in FIG. 3, the evaluation points of the constituent elements are “0”, “0.3”, “0”, “0.7”, “0”, “0”, “0.3”, “0”, “0.1”, and “0” in the order from the constituent element with the constituent element ID “C-001” to the constituent element with the constituent element ID “C-010”. Therefore, three constituent elements with the constituent element ID “C-002”, “C-004”, and “C-007” for which the evaluation point is equal to or greater than “0.3” are determined as the regions to which the query related region belongs. Described above is but an example of methods for determining the evaluation point, and any method may be used, provided that the computational algorithm is such that the constituent elements including a larger number of queries are easier to determine as the query related regions, and that among them the constituent elements including a larger number of query related information are easier to determine as the query related regions.

Explained hereinbelow is a method for determining a query related region by determining as a query related region a constituent element in which the “NUMBER OF QUERIES INCLUDED IN TEXT OF CONSTITUENT ELEMENT” or the “NUMBER OF TYPES OF RELATED INFORMATION INCLUDED IN TEXT OF CONSTITUENT ELEMENT” is equal to or greater than 1. Therefore, it follows from FIG. 3 that four constituent elements with the constituent element ID “C-002”, “C-004”, “C-007”, and “C-009” are determined as query related regions. Then, the save URL of the text information of the constituent elements to which the determined query related regions belong and the save URL of the style information of the constituent elements to which the determined query related regions belong are registered in the query related region information table T60.

More specifically, the “SAVE URL OF TEXT INFORMATION OF CONSTITUENT ELEMENT” and the “SAVE URL OF STYLE INFORMATION OF CONSTITUENT ELEMENT” of the four constituent elements with the constituent element ID “C-002”, “C-004”, “C-007”, and “C-009”, from the constituent element text information table T30 depicted in FIG. 3, are registered in association with the “TARGET Web PAGE ID” and “CONSTITUENT ELEMENT ID” in the “SAVE URL OF TEXT INFORMATION OF CONSTITUENT ELEMENT TO WHICH QUERY RELATED REGION BELONGS” and the “SAVE URL OF STYLE INFORMATION OF CONSTITUENT ELEMENT TO WHICH QUERY RELATED REGION BELONGS”, respectively, of the query related region information table T60 depicted in FIG. 6.

Further, likewise, the “APPEARANCE ORDER OF CONSTITUENT ELEMENT”, “NUMBER OF QUERIES INCLUDED IN TEXT OF CONSTITUENT ELEMENT”, and “NUMBER OF TYPES OF RELATED INFORMATION INCLUDED IN TEXT OF CONSTITUENT ELEMENT” of the four constituent elements with the constituent element ID “C-002”, “C-004”, “C-007”, and “C-009”, from the constituent element text information table T30 depicted in FIG. 3, are registered in the “APPEARANCE ORDER OF CONSTITUENT ELEMENT”, “NUMBER OF QUERIES INCLUDED IN TEXT OF CONSTITUENT ELEMENT”, and “NUMBER OF TYPES OF RELATED INFORMATION INCLUDED IN TEXT OF CONSTITUENT ELEMENT” of the query related region information table T60 depicted in FIG. 6.

Then, the position, width, and height of the constituent elements in the target Web page is acquired from the contents of the text information saved in the “SAVE URL OF STYLE INFORMATION OF CONSTITUENT ELEMENT TO WHICH QUERY RELATED INFORMATION BELONGS” with respect to the constituent elements with the constituent element ID “C-002”, “C-004”, “C-007”, and “C-009”, and the acquired information is registered in the query related region information table T60.

FIG. 5 illustrates a contents example of the style information saved in the “SAVE URL OF STYLE INFORMATION OF CONSTITUENT ELEMENT TO WHICH QUERY RELATED INFORMATION BELONGS” in the constituent element with the constituent element ID “C-002”. It follows from the figure that with respect to the constituent element with the constituent element ID “C-002”, in FIG. 5, the position of the constituent element becomes “(top, left)=(400 px, 0 px)” on the basis of the values of the “top” parameter and “left” parameter described in the CSS. This result indicates that the constituent element is arranged at a position of “400 px. In the downward direction and 0 px in the rightward direction, with the upper right portion of the text header of the Web page being taken as a reference position”. In FIG. 5, the “WIDTH OF CONSTITUENT ELEMENT” becomes “1920 px” on the basis of the “width” parameter described in the CSS. Further, in FIG. 5, the “HEIGHT OF CONSTITUENT ELEMENT” becomes “300 px” on the basis of the “height” parameter described in the CSS. The values of those parameters are registered as the “POSITION OF CONSTITUENT ELEMENT”, “WIDTH OF CONSTITUENT ELEMENT”, and “HEIGHT OF CONSTITUENT ELEMENT” of the constituent element with the constituent element ID “C-002” in the query related region information table T60.

Then, the type of the constituent elements in the target Web page is determined on the basis of the contents of the text information saved in the “SAVE URL OF TEXT INFORMATION OF CONSTITUENT ELEMENT TO WHICH QUERY RELATED INFORMATION BELONGS” with respect to the constituent elements with the constituent element ID “C-002”, “C-004”, “C-007”, and “C-009”, and the determined types of constituent elements are registered in the query related region information table T60. For example, the contents of the text file saved in the “SAVE URL OF TEXT INFORMATION OF CONSTITUENT ELEMENT” in the constituent element with the constituent element ID “C-002” is depicted in FIG. 4. As a result, the constituent element with the constituent element ID “C-002” includes the text information described by the “p” tag, as indicated in FIG. 4, and the type of the constituent element is text. Therefore, “text” is registered as the “TYPE OF CONSTITUENT ELEMENT” with the constituent element ID “C-002” in the query related region information table T60.

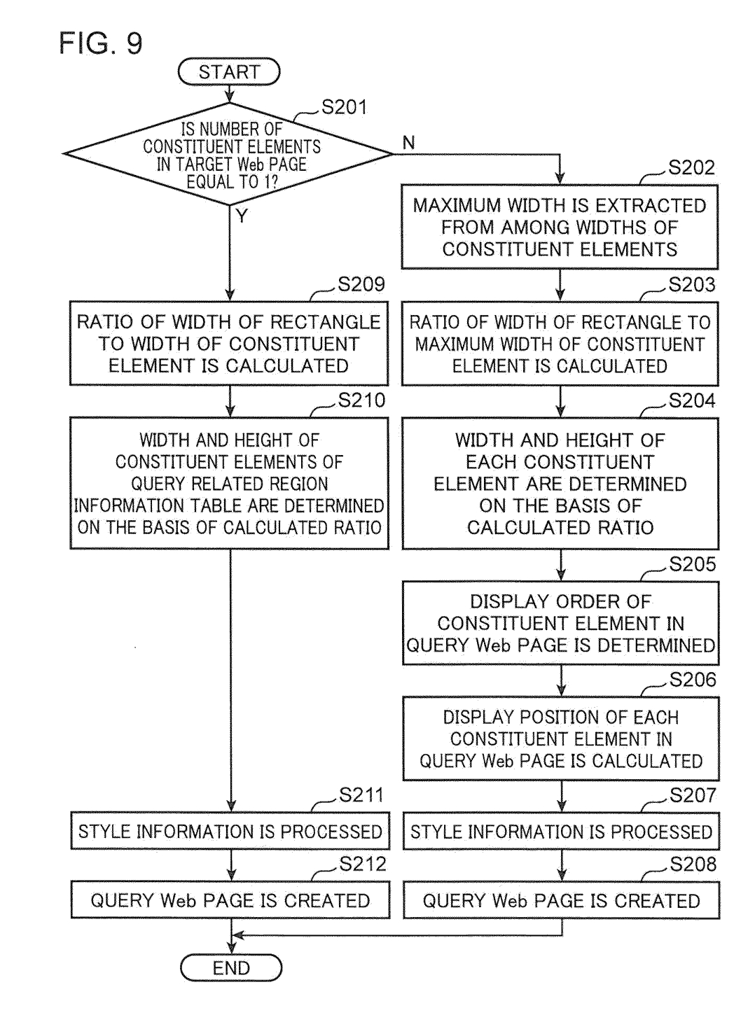

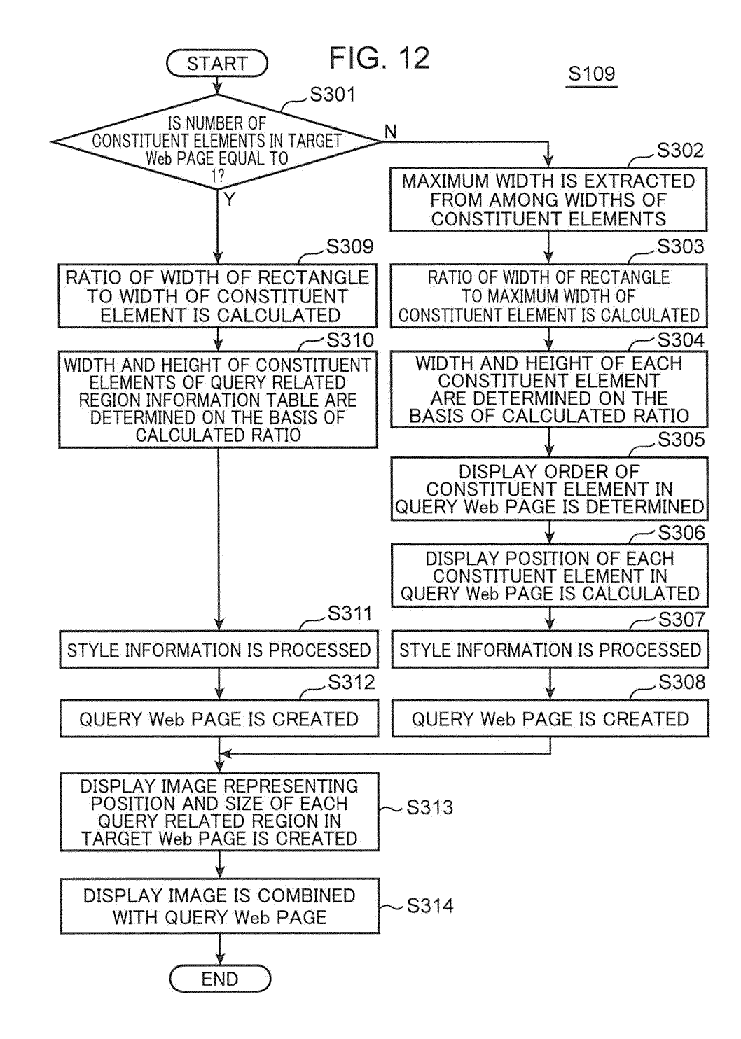

Then, the Web page creation unit 104 performs the query Web page creation processing (S109). The query Web page creation processing will be explained below in detail with reference to FIGS. 9 and 12.

Finally, the communication unit 105 transmits the created query Web page to the terminal device 300 via the network 200 (S110). As a result, the query Web page is displayed in the rectangle of the browser 301, and the information display control processing is completed.

As a result of the processing of S110, the user can browse, through the browser 301 by using a scroll operation, or the like, the query Web page constituted only by four constituent elements with the constituent element ID “C-002”, “C-004”, “C-007”, and “C-009”, which relate to the input query “BFD-PA600e” and query related information “FACIAL MASSAGER”. In this case, the browser 301 may be provided with a setting button that is associated with a link (for example, “http://beautypro.com/facecare”) of the URL of the target Web page before the information display control processing managed by the query information table T20 depicted in FIG. 2. Where the setting button is then pushed by the user, the browser 301 may switch the display from the query Web page to the original target Web page.

The flow of the creation processing of the first query Web page performed by the Web page creation unit 104 depicted in S109 will be explained below with reference to FIG. 9.

Initially, the Web page creation unit 104 checks whether or not the number of constituent elements of the target Web page is 1 in the query related region information table T60 depicted in FIG. 6 (S201). Where the number of constituent elements is not 1 (S201: N), the Web page creation unit 104 extracts the maximum width from among the widths of the constituent elements of the target Web page registered in the query related region information table T60 and registers the extracted maximum width in the “MAXIMUM WIDTH OF CONSTITUENT ELEMENT” of the query related region information table T60 (S202).

In the example of the query related region information table T60 depicted in FIG. 6, the number of the constituent elements of the target Web page is four (constituent elements with the constituent element ID “C-002”, “C-004”, “C-007”, and “C-009”), that is, the number of the constituent elements is not 1. Therefore, the processing advances to S202.

In S202, the maximum width is extracted from among the widths of the constituent elements with the constituent element ID “C-002”, “C-004”, “C-007”, and “C-009” to which the query related information belongs. In the example depicted in FIG. 6, the width of the constituent elements changes in the order of “1920 px”, “1920 px”, “480 px” and “960 px”. Therefore, “1920 px” is extracted as the maximum width and registered as the “MAXIMUM WIDTH OF CONSTITUENT ELEMENT” in the query related region information table T60.

Then, the Web page creation unit 104 compares the “MAXIMUM WIDTH OF CONSTITUENT ELEMENT” registered in the query related region information table T60 with the “WIDTH. OF RECTANGLE” registered in the query information table T20, and calculates the ratio of the “WIDTH OF RECTANGLE” to the “MAXIMUM WIDTH OF CONSTITUENT ELEMENT” (S203).

In the example of the query related region information table T60 depicted in FIG. 6, the “MAXIMUM WIDTH OF CONSTITUENT ELEMENT” is “1920 px”, and in the example of the query information table T20 depicted in FIG. 2, the “WIDTH OF RECTANGLE” is “640 px”. Therefore, the ratio of the “WIDTH OF RECTANGLE” to the “MAXIMUM WIDTH OF CONSTITUENT ELEMENT” is calculated as “640/1920=1/3”.

Then, the Web page creation unit 104 determines the width and height of each constituent element registered in the query related region information table T60 on the basis of the ratio “1/3” calculated in S203, and registers the determined width and height in the “DISPLAY WIDTH OF CONSTITUENT ELEMENT” and the “DISPLAY HEIGHT OF CONSTITUENT ELEMENT” of the query related region information table T60 (S204).

More specifically, the width and height of each constituent element registered in the query related region information table T60 depicted in FIG. 6 is multiplied by “1/3”, which is the ratio calculated in S203, and the “DISPLAY WIDTH OF CONSTITUENT ELEMENT” and the “DISPLAY HEIGHT OF CONSTITUENT ELEMENT” are calculated for each constituent element.

For example, the width and height of the constituent element with the constituent element ID “C-002” is “1920 px” and “300 px”, respectively, and the ratio of the “WIDTH OF RECTANGLE” to the “MAXIMUM WIDTH OF CONSTITUENT ELEMENT” is “1/3”. Therefore, the “DISPLAY WIDTH OF CONSTITUENT ELEMENT” and the “DISPLAY HEIGHT OF CONSTITUENT ELEMENT” of the constituent element with the constituent element ID “C-002” are calculated as “640 px (1920×(1/3) px)” and “100 px (=300 px×(1/3) px)”, respectively, and registered in the query related region information table T60. The “DISPLAY WIDTH OF CONSTITUENT ELEMENT” and the “DISPLAY HEIGHT OF CONSTITUENT ELEMENT” are calculated in the same manner with respect to the constituent elements with the constituent element ID “C-004”, “C-007”, and “C-009” and registered in the query related region information table T60, The calculation results are depicted in FIG. 6.

This calculation method is based on the idea of maintaining the ratio of dimensions between the constituent elements in the target Web page and using at the maximum limit the size of the rectangle of the browser 301 displaying the query Web page. Further, a method for calculating the display width and display height of each constituent element is not limited. For example, a method for calculating the display width and display height of each constituent element by which the width and height of each constituent element is enlarged or reduced by a factor that makes the width of all of the constituent elements equal to the width of the rectangle of the browser 301 may be also used.

Then, the Web page creation unit 104 determines the display order of each constituent element in the query Web page on the basis of the “DISPLAY WIDTH OF CONSTITUENT ELEMENT”, “DISPLAY HEIGHT OF CONSTITUENT ELEMENT”, “APPEARANCE ORDER OF CONSTITUENT ELEMENT”, “TYPE OF CONSTITUENT ELEMENT”, “NUMBER OF QUERIES INCLUDED IN TEXT OF CONSTITUENT ELEMENT”, and “RELATED INFORMATION INCLUDED IN TEXT OF CONSTITUENT ELEMENT” with respect to each constituent element registered in the query related region information table T60 and registers the determined display order in the query related region information table T60 (S205).

There are four methods for determining the display order of constituent elements of the query Web page. With the first method for determining the display order, the display order is determined on the basis of the display width and display height of the constituent elements to which the query related regions belong in the query Web page. When the first method for determining the display order is used, the evaluation points of the constituent elements are calculated and the display order of the constituent elements is determined by the computational algorithm according to which the evaluation point of the constituent element is increased in the descending order of the display width and the ascending order of the display height of the constituent elements. More specifically, a computational algorithm is used according to which the constituent elements are arranged in the descending order of the display width and the ascending order of the display height, the evaluation point of the constituent element with the largest order rank is taken as “0.1”, and the evaluation point is increased by “0.1” as the order rank decreases by 1.

In the example of the query related region information table T60 depicted in FIG. 6, where the constituent elements are arranged in the descending order of the display width and the ascending order of the display height of the constituent elements, the constituent elements with the constituent element ID “C-002” and “C-004” which have the largest “DISPLAY WIDTH OF CONSTITUENT ELEMENT” of “640 px” and the same display height of “100 px” are arranged with the same order rank. Then, the constituent element with the constituent element ID “C-009” which has a display width of the constituent element of “320 px” is arranged. Finally, the constituent element with the constituent element ID “C-007” which has a display width of the constituent element of “160 px” is arranged.

Therefore, the evaluation point of the constituent element with the constituent element ID “C-007” which has the largest order rank is “0.1”. The evaluation point of the constituent element with the constituent element ID “C-009” which has the order rank less by 1 is “0.2”. The evaluation points of the constituent elements with the constituent element ID “C-002” and “C-004” which have the order rank further less by 1 are “0.3” each.

In this case, when the constituent elements with equal evaluation points are present, an additional ranking may be performed, for example, by orderly displaying the constituent elements from the constituent element with a smallest value of the character string of the constituent element ID. In the present example, the constituent elements with the constituent element ID “C-002” and “C-004” have the same evaluation point “0.3”, but the value of the character string of the constituent element ID “C-002” is less than that of the constituent element ID “C-004”. Therefore, the display order of the constituent element with the constituent element ID “C-002” is less than that of the constituent element with the constituent element ID “C-004”. Further, the constituent elements of the query Web page are displayed in the descending display order of the evaluation point.

Therefore, with the first method for determining the display order, the following final display order is obtained: the constituent element with the constituent element ID “C-002”, then the constituent element with the constituent element ID “C-004”, then the constituent element with the constituent element ID “C-009”, and finally the constituent element with the constituent element ID “C-007”.

The method for calculating the evaluation point explained herein is based on the idea that a very large volume of information is efficiently displayed on the query Web page until the user performs a scroll operation. For example, the amount of information displayed in the constituent element with a large display width is likely to be larger than that displayed in the constituent element with a small display width, provided that the display height is the same. Therefore, a larger evaluation point is calculated for a constituent element with a larger display width. Further, where the evaluation point of the constituent element with a smaller display height, from among the two constituent elements with the same display width, is increased, the browser 301 is likely to be capable of displaying a larger number of constituent elements before the user performs the scroll operation. Therefore, a computational algorithm is used according to which the evaluation point increases for a constituent element with a larger display width and a smaller display height.

The second method for determining the display order is explained hereinbelow. With the second method for determining the display order, the display order is determined on the basis of the appearance order of the constituent elements in the target Web page. When the second method for determining the display order is used, the evaluation points of the constituent elements are calculated with the computational algorithm according to which the evaluation point of the constituent element is increased for a constituent element with a smaller “APPEARANCE ORDER OF CONSTITUENT ELEMENT” in the target Web page. For example, a computational algorithm is used according to which the constituent elements are arranged in the ascending order of the “APPEARANCE ORDER OF CONSTITUENT ELEMENT”, the evaluation point of the constituent element with the largest order rank is taken as “0.1”, and the evaluation point is increased by “0.1” as the order rank decreases by 1. In an example of the query related region information table T60 depicted in FIG. 6, where the constituent elements are arranged in the ascending order of the “APPEARANCE ORDER OF CONSTITUENT ELEMENT”, the first arranged is the constituent element with the constituent element ID “C-002” for which the “APPEARANCE ORDER OF CONSTITUENT ELEMENT” is the smallest and equal to “2”. Then, the constituent element with the constituent element ID “C-004” for which the appearance order of the constituent element is “4” is arranged. Then, the constituent element with the constituent element ID “C-007” for which the appearance order of the constituent element is “7” is arranged. Finally, the constituent element with the constituent element ID “C-009” for which the appearance order of the constituent element is “9” is arranged.

Therefore, the evaluation point is “0.1” for the constituent element with the constituent element ID “C-009” which has the lowest order rank, “0.2” for the constituent element with the constituent element ID “C-007” which has the order rank higher by 1, “0.3” for the constituent element with the constituent element ID “C-004” which has the order rank further higher by 1, and “0.4” for the constituent element with the constituent element ID “C-002” which has the order rank further higher by 1.

The constituent elements in the query Web page are then sequentially displayed from the constituent element with a largest evaluation point. Therefore, when the second method for determining the display order is used, the following final display order is obtained: initially the constituent element with the constituent element ID “C-002”, then the constituent element with the constituent element ID “C-004”, then the constituent element with the constituent element ID “C-007”, and finally the constituent element with the constituent element ID “C-009” are displayed.

The method for calculating the evaluation points described herein is based on the idea of displaying the constituent elements on the query Web page while maintaining the appearance order of the constituent elements in the target Web page. Therefore, the computational algorithm is used according to which the evaluation point of a constituent element is larger for a constituent element with a lower appearance order in the target Web page.

The third method for determining the display order is explained below. With the third method for determining the display order, the display order of the constituent elements on the query Web page is determined on the basis of the types of the constituent elements. In this case, for example, the constituent element with “text”, which indicates that the “TYPE OF CONSTITUENT ELEMENT” is a text, is assumed to have an evaluation point of “0.5”. The constituent element with “link”, which indicates that the “TYPE OF CONSTITUENT ELEMENT” is a link, is assumed to have an evaluation point of “0.3”. The constituent element with “image”, which indicates that the “TYPE OF CONSTITUENT ELEMENT” is an image, is assumed to have an evaluation point of “0.6”. The constituent element with “video”, which indicates that the “TYPE OF CONSTITUENT ELEMENT” is a video, is assumed to have an evaluation point of “0.7”. The constituent element with “form”, which indicates that the “TYPE OF CONSTITUENT ELEMENT” is an input-transmission form, is assumed to have an evaluation point of “0.2”. The constituent element with “table”, which indicates that the “TYPE OF CONSTITUENT ELEMENT” is a table, is assumed to have an evaluation point of “0.4”. The constituent element with “another tag”, which indicates that the “TYPE OF CONSTITUENT ELEMENT” is none of the above, is assumed to have an evaluation point of “0.1”. The evaluation points of the constituent element are thus calculated.

For the constituent element having a plurality of “TYPES OF CONSTITUENT ELEMENT”, the arithmetic average value of the evaluation points of all types is taken as the final evaluation point.

For example, for the constituent element for which the “TYPES OF CONSTITUENT ELEMENT” are “link” and “text”, initially, the evaluation points of “link” and “text” are added up to yield “0.8”, and then this value is divided by “2”, which is the number of types, and a final evaluation point of “0.4” is obtained. In this case, when a plurality of constituent elements with the same evaluation point is present, an additional ranking may be performed, for example, by displaying the constituent element in the order from the constituent element with a smallest value of the character string in the constituent element ID.

In the example of the query related region information table T60 depicted in FIG. 6, for the constituent element with the constituent element ID “C-002”, the “TYPE OF CONSTITUENT ELEMENT” is “text”, and therefore the evaluation point is “0.5”. For the constituent element with the constituent element ID “C-004”, the “TYPES OF CONSTITUENT ELEMENT” are “link” and “text”, and therefore the evaluation point is “(0.3+0.5)/2=0.4”. For the constituent element with the constituent element ID “C-007”, the “TYPE OF CONSTITUENT ELEMENT” is “image”, and therefore the evaluation point is “0.6”. For the constituent element with the constituent element ID “C-009”, the “TYPE OF CONSTITUENT ELEMENT” is “video”, and therefore the evaluation point is “0.7”.

The constituent elements in the query Web page are then displayed in the descending display order of the evaluation point. Therefore, when the third method for determining the display order is used, the following final display order is obtained: initially the constituent element with the constituent element ID “C-009”, then the constituent element with the constituent element ID “C-007”, then the constituent element with the constituent element ID “C-002”, and finally the constituent element with the constituent element ID “C-004” are displayed.

The method for calculating the evaluation point explained herein is based on the idea of displaying earlier on the query Web page a constituent element from which the user can obtain the amount of information with less effort. Therefore, for example, the user can obtain information by simply browsing a dynamic or static image. Further, the amount of information obtained by the user is likely to be larger from the dynamic image than from the static image. Therefore, the largest evaluation point is set for the dynamic image, and the next largest evaluation point is set for the static image.

The amount of information obtained by the user from the text is likely to be large, but the user is unlikely to be capable of browsing the entire information without performing the operations of scrolling, enlarging, and reducing. Therefore, the evaluation point for the text is set next to that for the static image. A table has a comparatively large amount of information, but the user is likely to be required to analyze and browse the contents of the table. Therefore, the evaluation point for the table is set next to that for the text.

A link has a comparatively small amount of information, and the user is required to push the link, Therefore, the evaluation point for the link is set next to that for the table. The input-transmission form is likely to have a small amount of information, and the user is likely to perform an operation of inputting a text or pushing a button. Therefore, the evaluation point for the input-transmission form is set next to that for the link.

The fourth method for determining the display order is explained below. With the fourth method for determining the display order, the display order of the constituent elements on the query Web page is determined on the basis of the number of queries and number of types of query related information included in each constituent element. For example, the evaluation points of the constituent elements are calculated with an algorithm according to which a larger evaluation point of a constituent element is calculated from a constituent element for which the number of queries included in the constituent element is the largest and the number of types of query related information included in the constituent element is also the largest More specifically, each time a query is included in a constituent element, the evaluation point of the constituent element is increased by “0.4”, and each time the number of types of query related information in the constituent element is increased by 1, the evaluation point of the constituent element is increased by “0.2”. In this case, when the constituent elements with equal evaluation points are present, an additional ranking may be performed, for example, by orderly displaying the constituent elements from the constituent element with a smallest value of the character string of the constituent element ID.

In the example of the query related region information table T60 depicted in FIG. 6, for the constituent element with the constituent element ID “C-002”, the “NUMBER OF QUERIES INCLUDED IN TEXT OF CONSTITUENT ELEMENT” is “1” and the “NUMBER OF TYPES OF RELATED INFORMATION INCLUDED IN TEXT OF CONSTITUENT ELEMENT” is “0”. Therefore, the evaluation point of this constituent element is “1×0.4+0×0.2=0.4”, For the constituent element with the constituent element ID “C-004”, the “NUMBER OF QUERIES INCLUDED IN TEXT OF CONSTITUENT ELEMENT” is “2” and the “NUMBER OF TYPES OF RELATED INFORMATION INCLUDED IN TEXT OF CONSTITUENT ELEMENT” is “1”. Therefore, the evaluation point of this constituent element is “2×0.4+1×0.2=1.0”. For the constituent element with the constituent element ID “C-007”, the “NUMBER OF QUERIES INCLUDED IN TEXT OF CONSTITUENT ELEMENT” is “1” and the “NUMBER OF TYPES OF RELATED INFORMATION INCLUDED IN TEXT OF CONSTITUENT ELEMENT” is “0”. Therefore, the evaluation point of this constituent element is “1×0.4+0×0.2=0.4”. For the constituent element with the constituent element ID “C-009”, the “NUMBER OF QUERIES INCLUDED IN TEXT OF CONSTITUENT ELEMENT” is “0” and the “NUMBER OF TYPES OF RELATED INFORMATION INCLUDED IN TEXT OF CONSTITUENT ELEMENT” is “1”. Therefore, the evaluation point of this constituent element is “0×0.4+1×0.2=0.2”.

In the present example, the constituent elements with the constituent element ID “C-002” and “C-007” have the same evaluation point of “0.4”, but the value of the character string of the constituent element ID “C-002” is less than that of the constituent element ID “C-007”. Therefore, the display order of the constituent element with the constituent element ID “C-002” is less than that of the constituent element with the constituent element ID “C-007”.

The display order of the constituent elements of the query Web page is the descending order of the evaluation point of the constituent element. Therefore, when the fourth method for determining the display order is used, the following final display order is obtained: initially the constituent element with the constituent element ID “C-004”, then the constituent element with the constituent element ID “C-002”, then the constituent element with the constituent element ID “C-007”, and finally the constituent element with the constituent element ID “C-009” are displayed.

The method for calculating the evaluation points described herein is based on the idea that the information required by the user is more likely to be described by the constituent elements including a larger number of queries, and among them, the information required by the user is more likely to be described by the constituent elements including a larger number of types of query related information. Further, the idea that, among the queries and types of query related information, the queries are likely to be closer to the information required by the user suggests that the evaluation point of the constituent element including one query is larger than the evaluation point of the constituent element including one type of query related information.

The display order of the constituent elements in the query Web page may be also determined by a method in which the first to fourth methods for determining the display order are combined together. For example, the evaluation points of the constituent elements calculated by the first to fourth methods for determining the display order are added up for each constituent element and the display order is determined in the order from the constituent element with a highest evaluation point. In this case, when the constituent elements with equal evaluation points are present, an additional ranking may be performed, for example, by orderly displaying the constituent elements from the constituent element with a smallest value of the character string of the constituent element ID.

More specifically, among the evaluation points of the constituent element with the constituent element ID “C-002”, the value calculated by the first method for determining the display order is “0.3”, the value calculated by the second method for determining the display order is “0.4”, the value calculated by the third method for determining the display order is “0.5”, and the value calculated by the fourth method for determining the display order is “0.4”. Therefore, the final evaluation point of this constituent element is “1.6” which is obtained by adding up those values.

Likewise, the final evaluation point of the constituent element with the constituent element ID “C-004” is “0.3++0.3+0.4+1.0=2.0”, the final evaluation point of the constituent element with the constituent element ID “C-007” is “0.1+0.2±0.6+0.4=1.3”, and the final evaluation point of the constituent element with the constituent element ID “C-009” is “0.2+0.1+0.7+0.2=1.2”. The display order of the constituent elements in the query Web page is in the descending order of the evaluation point. Therefore, when the first to fourth methods for determining the display order are combined together, the following final display order of the constituent elements of the query Web page is obtained: initially the constituent element with the constituent element ID “C-004”, then the constituent element with the constituent element ID “C-002”, then the constituent element with the constituent element ID “C-007”, and finally the constituent element with the constituent element ID “C-009” are displayed.

When the first to fourth methods for determining the display order are combined together, the final evaluation point of each constituent element may be calculated by adding up, with weighting factors, the evaluation points of the constituent elements calculated in each of the first to fourth methods for determining the display order.

For example, when the weighting of the “APPEARANCE ORDER OF CONSTITUENT ELEMENT” (second method for determining the display order) is increased and the weighting of the “NUMBER OF QUERIES AND NUMBER OF TYPES OF QUERY INFORMATION INCLUDED IN EACH CONSTITUENT ELEMENT” (fourth method for determining the display order) is decreased, the evaluation point of each constituent element calculated on the basis of “APPEARANCE ORDER OF CONSTITUENT ELEMENT” (second method for determining the display order) is weighted by a factor of 2, and the evaluation point of each constituent element calculated on the basis of the “NUMBER OF QUERIES AND NUMBER OF TYPES OF QUERY INFORMATION INCLUDED IN EACH CONSTITUENT ELEMENT” (fourth method for determining the display order) is weighted by a factor of 1/2. Then, the weighted evaluation points based on the second and fourth methods for determining the display order, the evaluation point calculated on the basis of the first method for determining the display order, and the evaluation point calculated on the basis of the third method for determining the display order are added up for each constituent element, and final evaluation points are calculated. In this case, when the constituent elements with equal evaluation points are present, an additional ranking may be performed, for example, by orderly displaying the constituent elements from the constituent element with a smallest value of the character string of the constituent element ID.

More specifically, among the evaluation points of the constituent element with the constituent element ID “C-002”, the value calculated by the first method for determining the display order is “0.3”, the value obtained by weighting by a factor of 2 the value calculated by the second method for determining the display order is “0.4×2=0.8”, the value calculated by the third method for determining the display order is “0.5”, and the value obtained by weighting by a factor of 1/2 the value calculated by the fourth method for determining the display order is “0.4×1/2=0.2”. Therefore, the final evaluation point of this constituent element is “1.8” which is obtained by adding up those values.

Likewise, the final evaluation point of the constituent element with the constituent element ID “C-004” is “0.3+0.3×2+0.4+1.0×1/2=1.8”, the final evaluation point of the constituent element with the constituent element ID “C-007” is “0.1+0.2×2+0.6+0.4×1/2=1.3”, and the final evaluation point of the constituent element with the constituent element ID “C-009” is “0.2+0.1×2+0.7+0.2×1/2=1.2”.

In the present example, the constituent elements with the constituent element ID “C-002” and “C-004” have the same evaluation point of “1.8”, but the value of the character string of the constituent element ID “C-002” is less than that of the constituent element ID “C-004”. Therefore, the display rank of the constituent element with the constituent element ID “C-002” is lower. Further, the display order of the constituent elements in the query Web page is the descending order of the evaluation point.

Therefore, the following final display order is obtained in this case: initially the constituent element with the constituent element ID “C-002”, then the constituent element with the constituent element ID “C-004”, then the constituent element with the constituent element ID “C-007”, and finally the constituent element with the constituent element ID “C-009” are displayed.

Described below are the exemplary methods for calculating the evaluation point, but the present disclosure is not limited to those calculation methods.

The display order of the constituent elements of the query Web page is determined in the above-described manner, and the determined display order of the constituent elements is registered in the query related region information table T60 depicted in FIG. 6. FIG. 6 shows the calculation result of the display order in the case in which the above-described first to fourth methods for determining the display order are combined and the evaluation points calculated by the second and fourth methods for determining the display order are weighted. Therefore, in FIG. 6, the display order of the constituent element with the constituent element ID “C-002” is registered as “1”, the display order of the constituent element with the constituent element ID “C-004” is registered as “2”, the display order of the constituent element with the constituent element ID “C-007” is registered as “3”, and the display order of the constituent element with the constituent element ID “C-009” is registered as “4”.

Then, the Web page creation unit 104 calculates the “DISPLAY POSITION OF CONSTITUENT ELEMENT” for each constituent element of the query Web page on the basis of the “DISPLAY ORDER OF CONSTITUENT ELEMENT” and the “DISPLAY HEIGHT OF CONSTITUENT ELEMENT” registered in the query related region information table T60, and registers the calculation result in the query related region information table T60 (S206).

More specifically, initially, a predetermined value, for example “0 px”, is set as the value of the “left” parameter of the “DISPLAY POSITION OF CONSTITUENT ELEMENT” for each constituent element of the query Web page. Meanwhile, “0 px” is set as the “top” parameter of the “DISPLAY POSITION OF CONSTITUENT ELEMENT” for the constituent element with the display order of “1”.

Then, for the constituent element with the display order of or after “2”, a value obtained by adding up the value of the “top” parameter of the “POSITION OF CONSTITUENT ELEMENT” and the value of the “DISPLAY HEIGHT OF CONSTITUENT ELEMENT” of the constituent element with the “DISPLAY ORDER OF CONSTITUENT ELEMENT” less by 1 is set as the value of the “top” parameter of the “DISPLAY POSITION OF CONSTITUENT ELEMENT”.

For example, with respect to the constituent element with the “DISPLAY ORDER OF THE CONSTITUENT ELEMENT” of “2”, “100 px” which is a value obtained by adding up “0 px” which is the value of the “top” parameter of the “DISPLAY POSITION OF CONSTITUENT ELEMENT” and “100 px” which is the value of the “DISPLAY HEIGHT OF CONSTITUENT ELEMENT” of the constituent element with the “DISPLAY ORDER OF CONSTITUENT ELEMENT” of “1” is set as the value of the “top” parameter of the “DISPLAY POSITION OF CONSTITUENT ELEMENT”. Likewise, with respect to the constituent element with the “DISPLAY ORDER OF CONSTITUENT ELEMENT” of “3”, a value obtained by adding up the value of the “top” parameter of the “DISPLAY POSITION OF CONSTITUENT ELEMENT” and the value of the “DISPLAY HEIGHT OF CONSTITUENT ELEMENT” of the constituent element with the DISPLAY ORDER OF CONSTITUENT ELEMENT less by 1 is set as the value of the “top” parameter of the “DISPLAY POSITION OF CONSTITUENT ELEMENT”.

In this case, for the constituent element with the “DISPLAY ORDER OF CONSTITUENT ELEMENT” of “3”, “200 px” which is a value obtained by adding up “100 px” which is the value of the “top” parameter of the “DISPLAY POSITION OF CONSTITUENT ELEMENT” and “100 px” which is the “DISPLAY HEIGHT OF CONSTITUENT ELEMENT” of the constituent element with the “DISPLAY ORDER OF CONSTITUENT ELEMENT” of “2” is set as the value of the “top” parameter of the “DISPLAY POSITION OF CONSTITUENT ELEMENT”.

Likewise, for the constituent element with the “DISPLAY ORDER OF CONSTITUENT ELEMENT” of “4”, a value obtained by adding up the value of the “top” parameter of the “DISPLAY POSITION OF CONSTITUENT ELEMENT” and the value of the “DISPLAY HEIGHT OF CONSTITUENT ELEMENT” of the constituent element with the “DISPLAY ORDER OF CONSTITUENT ELEMENT” of “3” is set as the value of the “top” parameter of the “DISPLAY POSITION OF CONSTITUENT ELEMENT”.

More specifically, for the constituent element with the display order of “4”, “320 px” which is a value obtained by adding up “200 px” which is the value of the “top” parameter of the “DISPLAY POSITION OF CONSTITUENT ELEMENT” and “120 px” which is the “DISPLAY HEIGHT OF CONSTITUENT ELEMENT” of the constituent element with the “DISPLAY ORDER OF CONSTITUENT ELEMENT” of “3” is set as the value of the “top” parameter of the “DISPLAY POSITION OF CONSTITUENT ELEMENT”. As a result, in the query related region information table T60 depicted in FIG. 6, for the constituent element with the constituent element ID “C-002”, “(top, left)=(0 px, 0 px)” is registered as the “DISPLAY POSITION OF CONSTITUENT ELEMENT”. For the constituent element with the constituent element ID “C-004”, “(top, left)=(100 px, 0 px)” is registered as the “DISPLAY POSITION OF CONSTITUENT ELEMENT”. Further, for the constituent element with the constituent element ID “C-007”, “(top, left)=(200 px, 0 px)” is registered as the “DISPLAY POSITION OF CONSTITUENT ELEMENT”. For the constituent element with the constituent element ID “C-009”, “(top, left)=(320 px, 0 px)” is registered as the “DISPLAY POSITION OF CONSTITUENT ELEMENT”.

Then, the Web page creation unit 104 processes the style information of each constituent element on the basis of the “DISPLAY WIDTH OF CONSTITUENT ELEMENT”, “DISPLAY HEIGHT OF CONSTITUENT ELEMENT”, and “DISPLAY POSITION OF CONSTITUENT ELEMENT” with respect to each constituent element of the query related region information table T60 and saves the processed information in the “SAVE URL OF STYLE INFORMATION OF CONSTITUENT ELEMENT TO WHICH QUERY RELATED REGION BELONGS” (S207).

More specifically, as follows from the query related region information table T60, for example, for the constituent element with the constituent element ID “C-002”, the “DISPLAY WIDTH OF CONSTITUENT ELEMENT” is “640 px”, the “DISPLAY HEIGHT OF CONSTITUENT ELEMENT” is “100 px”, and the “DISPLAY POSITION OF CONSTITUENT ELEMENT” is “(0 px, 0 px)”. Therefore, the style information of this constituent element is processed in the following manner and saved in “http://tmp/w00001/s/c002.txt” which is the “SAVE URL OF STYLE INFORMATION OF CONSTITUENT ELEMENT TO WHICH QUERY RELATED REGION BELONGS”.

#C-002 {

width: 640 px;
height: 100 px;
position: absolute;
top: 0 px;
left: 0 px;

}

In this case, the “width” parameter is changed from the original “1920 px” to “640 px” which is the “DISPLAY WIDTH OF CONSTITUENT ELEMENT” in the query related region information table T60. Further, the “height” parameter is changed from the original “300 px” to “100 px” which is the “DISPLAY HEIGHT OF CONSTITUENT ELEMENT” in the query related region information table T60. The “top” parameter is changed from the original “400 px” to “0 px” which is the “top” parameter of the “DISPLAY POSITION OF CONSTITUENT ELEMENT” in the query related region information table T60.

Likewise, the style information of the constituent elements with the constituent element ID “C-004”, “C-007”, and “C-007” is processed in the following order and saved in “http://tmp/w00001/s/c004.txt”, “http://tmp/w00001/s/c007.txt”, and “http://tmp/w00001/s/c009.txt”, which are the “SAVE URL OF STYLE INFORMATION OF CONSTITUENT ELEMENT TO WHICH QUERY RELATED REGION BELONGS”.

#C-004 {

width: 640 px;
height: 100 px;
position: absolute;
top: 100 px;
left: 0 px;

}

In this case, the “width” parameter is changed from the original “1920 px” to “640 px” which is the “DISPLAY WIDTH OF CONSTITUENT ELEMENT” in the query related region information table T60. Further, the “height” parameter is changed from the original “300 px” to “100 px” which is the “DISPLAY HEIGHT OF CONSTITUENT ELEMENT” in the query related region information table T60. The “top” parameter is changed from the original “400 px” to “100 px” which is the “top” parameter of the “DISPLAY POSITION OF CONSTITUENT ELEMENT” in the query related region information table T60.

#C-007 {

width: 160 px;
height: 120 px;
position: absolute;
top: 200 px;
left: 0 px;

}

In this case, the “width” parameter is changed from the original “480 px” to “160 px” which is the “DISPLAY WIDTH OF CONSTITUENT ELEMENT” in the query related region information table T60. Further, the “height” parameter is changed from the original “360 px” to “120 px” which is the “DISPLAY HEIGHT OF CONSTITUENT ELEMENT” in the query related region information table T60. The “top” parameter is changed from the original “2100 px” to “200 px” which is the “top” parameter of the “DISPLAY POSITION OF CONSTITUENT ELEMENT” in the query related region information table T60.

#C-009 {

width: 320 px;
height: 180 px;
position: absolute;
top: 320 px;
left: 0 px;

}

In this case, the “width” parameter is changed from the original “960 px” to “320 px” which is the “DISPLAY WIDTH OF CONSTITUENT ELEMENT” in the query related region information table T60. Further, the “height” parameter is changed from the original “540 px” to “180 px” which is the “DISPLAY HEIGHT OF CONSTITUENT ELEMENT” in the query related region information table T60. The “top” parameter is changed from the original “2800 px” to “320 px” which is the “top” parameter of the “DISPLAY POSITION OF CONSTITUENT ELEMENT” in the query related region information table T60.

Finally, the Web page creation unit 104 creates the query Web page with respect to each constituent element of the query related region information table T60 on the basis of the “DISPLAY ORDER OF CONSTITUENT ELEMENT”, text information saved in the “SAVE URL OF TEXT INFORMATION OF CONSTITUENT ELEMENT TO WHICH QUERY RELATED REGION BELONGS”, style information saved in the “SAVE URL OF STYLE INFORMATION OF CONSTITUENT ELEMENT TO WHICH QUERY RELATED REGION BELONGS”, predetermined HTML text information, and CSS text information (S208), and thus completes the first Web page creation processing.

Specifically, the constituent elements of the query related region information table T60 are joined together according to the “DISPLAY ORDER OF CONSTITUENT ELEMENT”. In this case, the constituent elements are joined in the order of constituent element ID “C-002”, “C-004”, “C-007”, and “C-009”. The contents of the text files saved in the “SAVE URL OF TEXT INFORMATION OF CONSTITUENT ELEMENT TO WHICH QUERY RELATED REGION BELONGS” are joined, and the contents of the text files saved in the “SAVE URL OF STYLE INFORMATION OF CONSTITUENT ELEMENT TO WHICH QUERY RELATED REGION BELONGS” are separately joined.

In this case, the predetermined HTML text information is additional necessary information for creating the query Web page by joining together the text information of the constituent elements to which the query related regions belong. More specifically, HTML version information, HTML header information, and HTML body information are included as the predetermined HTML text information. For example, information in which the target Web page ID (for example, W-00001) is set as a CSS file name and title value serves as the HTML header information.

The HTML version information is the following information:

<!DOCTYPE HTML PUBLIC “-//W3C//DTDHTML 4.01
Transitional//EN”
“http://www.w3.org/TR/html4/loose.dtd”><html>
...
</html>.

The HTML header information in which the target Web page ID (for example, W-00001) is set to the CSS file name and title value is the following information:

<head>
<meta http-equiv=“Content-Type” content = “text/html;
charset=Shift_JIS”/>
<link rel=“stylesheet” type=“text/css” href=“W-00001.css”/>
<meta http-equiv=“Content-Script-Type” content=“text/javascript”/>
<title>W-00001</title>
</head>

The HTML body information, as referred to herein, is the information bounded by “body” tags as descried hereinbelow.

<body>
...
</body>

The predetermined CSS text information, as referred to herein, is the additional information necessary for joining together the style information of the constituent elements to which the query related regions belong and creating the query Web page. More specifically, the predetermined CSS text information is encode information of the following style sheet.

@charset “Shift_JIS”;

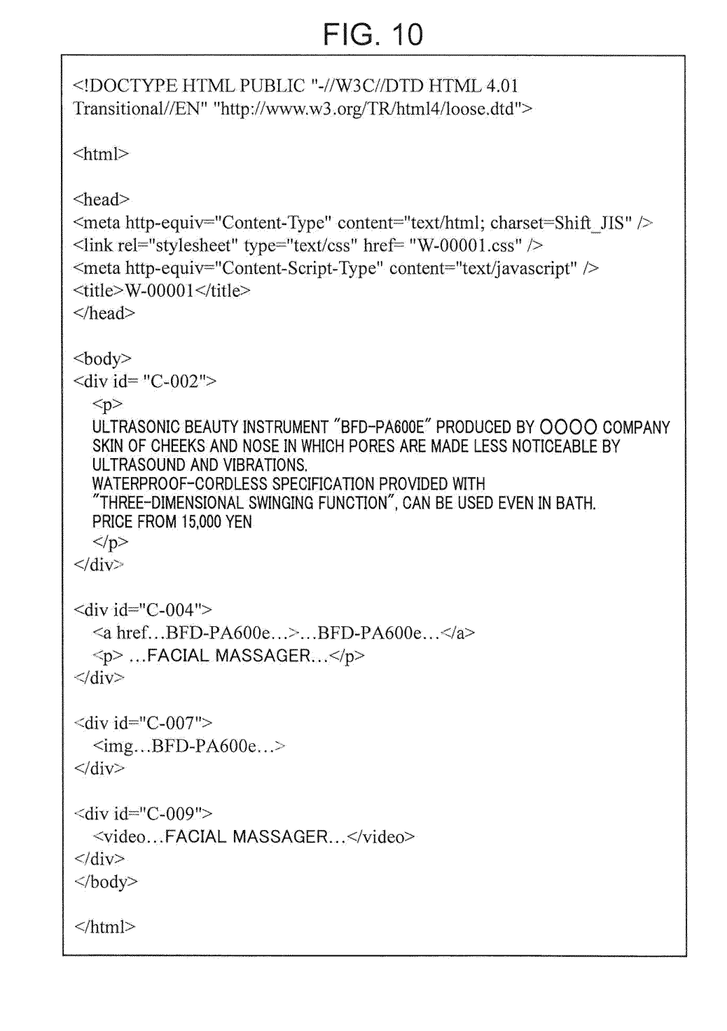

Then, the text information is joined that is saved in the “SAVE URL OF TEXT INFORMATION OF CONSTITUENT ELEMENT TO WHICH QUERY RELATED REGION BELONGS” in the order of the constituent elements with the constituent element ID “C-002”, “C-004”, “C-007”, and “C-009”. The predetermined HTML text information is joined, as depicted in FIG. 10, before and after of the joined text information, and the text information of the query Web page is created.

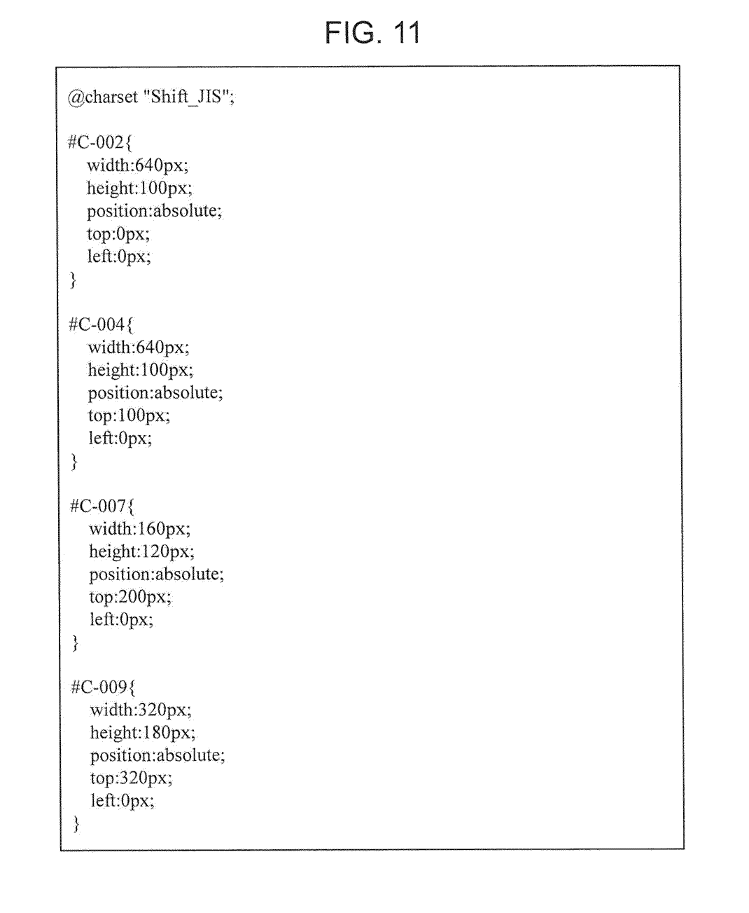

Then, the style information is joined that is saved in the “SAVE URL OF STYLE INFORMATION OF CONSTITUENT ELEMENT TO WHICH QUERY RELATED REGION BELONGS” in the order of the constituent elements with the constituent element ID “C-002”, “C-004”, “C-007”, and “C-009”. The predetermined CSS text information is joined, as depicted in FIG. 11, before the joined style information, and the style information of the query Web page is created. Finally, the query Web page is created using the created text information style information of the query Web page.

Meanwhile, when the number of the constituent element in the target Web page is 1 (S201: Y), the Web page creation unit 104 compares the “WIDTH OF CONSTITUENT ELEMENT” in the query related region information table T60 with the “WIDTH OF RECTANGLE” of the query information table T20 and calculates the ratio of the “WIDTH OF RECTANGLE” to the “WIDTH OF CONSTITUENT ELEMENT” (S209).

Then, the Web page creation unit 104 determines the weight and height of the constituent elements registered in the query related region information table T60 on the basis of the calculated ratio, and registers the calculated width and height in the “DISPLAY WIDTH OF CONSTITUENT ELEMENT” and “DISPLAY HEIGHT OF CONSTITUENT ELEMENT” of the query related region information table T60 (S210).

Then, the Web page creation unit 104 processes the style information of the constituent elements on the basis of the “DISPLAY WIDTH OF CONSTITUENT ELEMENT”, “DISPLAY HEIGHT OF CONSTITUENT ELEMENT”, and “DISPLAY POSITION OF CONSTITUENT ELEMENT” registered in the query related region information table T60 and saves the processed style information in the “SAVE URL OF STYLE INFORMATION OF CONSTITUENT ELEMENT TO WHICH QUERY RELATED REGION BELONGS” (S211). In this case, the “DISPLAY POSITION OF CONSTITUENT ELEMENT” is, for example, (top, left)=(0 px, 0 px).

Finally, the Web page creation unit 104 creates the query Web page on the basis of the text information saved in the “SAVE URL OF TEXT INFORMATION OF CONSTITUENT ELEMENT TO WHICH QUERY RELATED REGION BELONGS” of the query related region information table T60, the style information saved in the “SAVE URL OF STYLE INFORMATION OF CONSTITUENT ELEMENT TO WHICH QUERY RELATED REGION BELONGS”, the predetermined HTML text information, and CSS text information (S212), and completes the first query Web page creation processing.

Specific examples of processing of S209 to S212 are the same as in the case in which the constituent element to which the query related region belongs of the target Web page with the target Web page ID “W-00001” in the above-described S203, S204, S207, and S208 is, for example, only the constituent element with the constituent element ID “C-002”, and the explanation of those examples is herein omitted.

The flow of the second query Web page creation processing performed by the Web page creation unit 104 and illustrated by S109 will be explained hereinbelow with reference to FIG. 12. The second query Web page creation processing performed by the Web page creation unit 104 and illustrated by S109, as referred to herein, is specifically the processing of creating display images representing the positions and sizes of the query related regions in the target Web page, and combining the created display images with the query Web page.

S301 to S312 depicted in FIG. 12 are the same as S201 to S212 depicted in FIG. 9. Therefore, the explanation thereof is herein omitted.

After the processing of S312, the Web page creation unit 104 creates display images representing the position and size of each query related region in the target Web page on the basis of the “WIDTH OF Web PAGE” and “HEIGHT OF Web PAGE” in the constituent element text information table T30 depicted in FIG. 3 and also the “POSITION OF CONSTITUENT ELEMENT”, “WIDTH OF CONSTITUENT ELEMENT”, and “HEIGHT OF CONSTITUENT ELEMENT” of the query related region information table T60 depicted in FIG. 6 (S313).

For example, initially, “1920 px” and “3240 px” registered in the “WIDTH OF Web PAGE” and “HEIGHT OF Web PAGE” in the constituent element text information table T30 depicted in FIG. 3 are acquired with respect to the target Web page with the target Web page ID “W-00001”.

Then, the “POSITION OF CONSTITUENT ELEMENT”, “WIDTH OF CONSTITUENT ELEMENT”, and “HEIGHT OF CONSTITUENT ELEMENT” are acquired with respect to the each constituent element registered in the query related region information table T60 depicted in FIG. 6.

For example, “(top, left)=(400 px, 0 px)”, “1920 px”, and “300 px” are acquired as the “POSITION OF CONSTITUENT ELEMENT”, “WIDTH OF CONSTITUENT ELEMENT”, and “HEIGHT OF CONSTITUENT ELEMENT” with respect to the constituent element with the constituent element ID “C-002”.

Further, “(top, left)=(1100 px, 0 px)”, “1920 px”, and “300 px” are acquired as the “POSITION OF CONSTITUENT ELEMENT”, “WIDTH OF CONSTITUENT ELEMENT”, and “HEIGHT OF CONSTITUENT ELEMENT” with respect to the constituent element with the constituent element ID “C-004”.

Further, “(top, left)=(2100 px, 200 px)”, “480 px”, and “360 px” are acquired as the “POSITION OF CONSTITUENT ELEMENT”, “WIDTH OF CONSTITUENT ELEMENT”, and “HEIGHT OF CONSTITUENT ELEMENT” with respect to the constituent element with the constituent element ID “C-007”.

Further, “(top, left)=(2800 px, 400 px)”, “960 px”, and “540 px” are acquired as the “POSITION OF CONSTITUENT ELEMENT”, “WIDTH OF CONSTITUENT ELEMENT”, and “HEIGHT OF CONSTITUENT ELEMENT” with respect to the constituent element with the constituent element ID “C-009”.

For example, a white image with the surface area (1920 px×3240 px) same that of the target Web page is created. Then, for example, black images with the surface area (“1920 px×300 px”, “1920 px×300 px”, “480 px×360 px”, and “960 px×540 px”, respectively) same as that of the constituent elements with the constituent element ID “C-002”, “C-004”, “C-007”, and “C-009”, respectively, are created. Then the four created black images are arranged at positions in the white image that are equivalent to the arrangement positions of the constituent elements with the constituent element ID “C-002”, “C-004”, “C-007”, and “C-009” on the target Web page.

More specifically, the upper left apex of the created white image is taken as a reference position. Then, the black image corresponding to the constituent element ID “C-002” is arranged at the “position which is 400 px downward and 0 px rightward” on the white image. The black image corresponding to the constituent element ID “C-004” is arranged at the “position which is 1100 px downward and 0 px rightward” on the white image. The black image corresponding to the constituent element ID “C-007” is arranged at the “position which is 2100 px downward and 200 px rightward” on the white image. Further, the black image created at the “position which is 2800 px downward and 400 px rightward” is arranged on the white image.

The white image on which the four black images have been arranged is reduced in size at a predetermined ratio (for example, 5%) to create an icon. This icon is the display image indicating the position and size of each query related position in the target Web page. This icon is referred to hereinbelow as a query icon.

Then, the Web page creation unit 104 combines the query icon created in S313 with the query Web page (S314), and ends the second query Web page creation processing. More specifically, the query icon created in S313 is arranged, for example, in the upper right portion of the query Web page. The query icon is also combined with the query Web page by using, for example, a CSS “z-index: 100;” parameter. As a result, the query icon is displayed in a state of being fixed to the upper right portion of the rectangle of the browser 301 even when the user scrolls the query Web page.

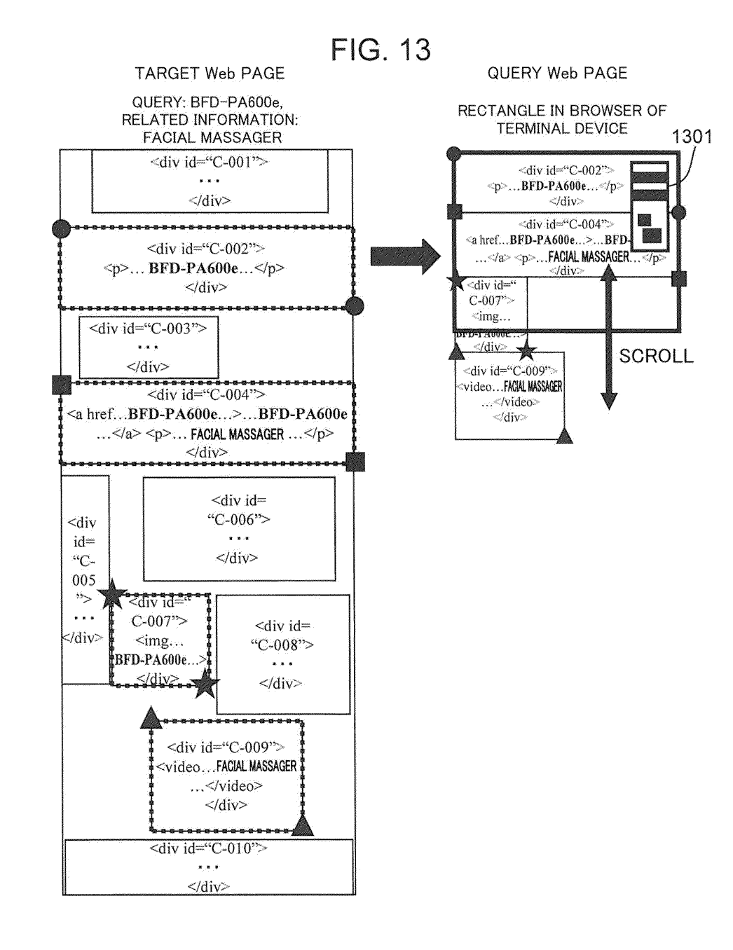

As depicted in the right drawing in FIG. 13, a query icon 1301 is arranged in the upper right portion of the rectangle of the browser 301. The left drawing in FIG. 13 depicts schematically the constituent elements constituting the target Web page and is the same as the left drawing in FIG. 7. In the right drawing in FIG. 13, some of the constituent elements with the constituent element ID “C-002”, “C-004”, and “C-007” are displayed within the rectangle (the last constituent element being displayed partially), but the constituent element with the constituent element ID “C-009” is not displayed within the rectangle. Further, where the user performs a scroll operation, the query Web page is scrolled upward, and the constituent element with the constituent element ID “C-007” and the constituent element with the constituent element ID “C-009” are displayed within the rectangle. In this case, the query icon 1301 is displayed at the same position within the rectangle. As a result, the query icon 1301 is prevented from being hidden when the query Web page is scrolled. Therefore, the user can use the query icon 1301 at all times to verify the position at which the presently displayed constituent elements are arranged on the target Web page.

In this example, the query icon 1301 is used as a display image indicating the position and size of each query related region in the Web page, and the query icon 1301 is combined with the query Web page. However, this is only an example. Thus, the display image indicating the position and size of the query related regions is not restricted to a Web page and may be used, for example, in a static image or a dynamic image.

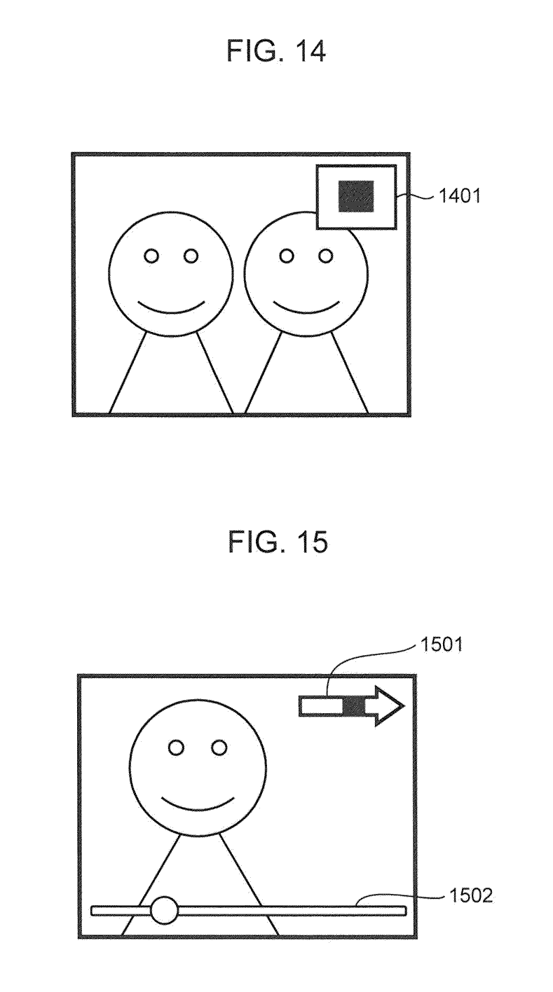

More specifically, where a region which is part of a static image is extracted as a query related region from the static image, a query icon describing the position and size of the query related region in the static image may be created in the same manner as in the above-described case of the Web page. In this case, an image where black rectangles corresponding to the query related region are disposed on the white rectangle representing the entire static image can be used. FIG. 14 depicts a display example of a display describing the position and size of a query related region in the static image. In the example depicted in FIG. 14, a query icon 1401 describing the position and size of the query related region in the static image is, for example, arranged in the upper right portion of the static image and combined with the static image.

In the query icon 1401 depicted in FIG. 14, the size of the white rectangle represents the size of the original static image. Further, the position of the black rectangle in the white rectangle represents the position of the query related region in the original static image. The size of the black rectangle in the white rectangle represents the size of the query related region in the original static image. The user can rapidly verify the position of the query related region in the static image by looking at the query icon 1401.

In a dynamic image, where a frame image which is part of a dynamic image is extracted as a query related region, a query icon describing the reproduction start position, reproduction end position, and reproduction time of the query related region in the dynamic image is created. FIG. 15 depicts a display example of a display describing the position and size of the query related region in the dynamic image.

As depicted in FIG. 15, an image in which a black rectangle is displayed in a white arrow is used as a query icon 1501. The length of the white arrow represents the reproduction time of the original dynamic image. The position of the left side of the black rectangle represents the reproduction start position of the query related region in the original dynamic image. The position of the right side of the black rectangle represents the reproduction end position of the query related region in the original dynamic image. The transverse width of the black rectangle represents the length of the query related region in the original dynamic image. The query icon 1501 is displayed, for example, in the upper right portion of the dynamic image.

The user can rapidly verify the reproduction start position of the query related region by looking at the query icon 1501. Further, by sliding a slide bar 1502 displayed in the lower portion of the screen of the dynamic image, the user can instantly start the reproduction of the query related region. In this case, the slide bar 1502 extends in the transverse direction, and the entire length thereof corresponds to the entire length of the white arrow of the query icon 1501. Therefore, the user can easily specify the reproduction start position of the query related region in the slide bar 1502 from the relative mutual arrangement of the black rectangle and white rectangle in the query icon 1501.

### Variation Example 1

In S203 and S204, the display width and display height of each constituent element of the query Web page is calculated by determining the ratio of the width of the rectangle of the browser 301 to the maximum width of the constituent element to which the query related region belongs and multiplying the width and height of each constituent element by the determined ratio. However, this is only an example. Thus, the display width and display height of each constituent element of the query Web page may be also calculated, for example, by determining the ratio of the height of the rectangle of the browser 301 to the maximum height of the constituent element to which the query related region belongs and multiplying the width and height of each constituent element by the determined ratio.

For example, in the example depicted in FIG. 6, the maximum value of the “HEIGHT OF CONSTITUENT ELEMENT” in the four constituent elements is “540 px”. In the example depicted in FIG. 2, the “HEIGHT OF RECTANGLE” is “540 px”. Therefore, the ratio of the “HEIGHT OF RECTANGLE” to the maximum value of the “HEIGHT OF CONSTITUENT ELEMENT” is “540 px/540 px=I”. As a result, the display width and display height of the constituent element of the query Web page is determined by multiplying the width and height by a factor of 1 for each constituent element registered in FIG. 6.

This method is effective when the rectangle of the browser 301 extends in the transverse direction and the query Web page is created by arranging the constituent elements to which the query related regions belong in the transverse direction.

### Variation Example 2

In the first method for determining the display order, the display order is determined to decrease for a constituent element to which belongs a query related region with a larger display width and a smaller display height in the query Web page, but such an example is not limiting. For example, the display order may be determined to decrease for a constituent element to which belongs a query related region with a smaller display width and a larger display height in the query Web page.

More specifically, a computational algorithm can be used according to which the constituent elements are arranged in the ascending order of the display width and the descending order of the display height, the evaluation point of the constituent element with the largest order rank is taken as “0.1”, and the evaluation point is increased by “0.1” for each decrease of the order rank by 1.

In the example of the query related region information table T60 depicted in FIG. 6, where the constituent elements are arranged in the ascending order of the display width and the descending order of the display height of the constituent element, the first arranged is the constituent element with the constituent element ID “C-009” which has the largest “DISPLAY HEIGHT OF CONSTITUENT ELEMENT” of “180 px”. Then, the constituent element with the constituent element ID “C-007” with the “DISPLAY HEIGHT OF CONSTITUENT ELEMENT” of “120 px” is arranged. Then, the constituent elements with the constituent element ID “C-002” and constituent element ID “C-004” having the same value of the “DISPLAY HEIGHT OF CONSTITUENT ELEMENT” of “100 px” and the same value of the “DISPLAY WIDTH OF CONSTITUENT ELEMENT” of “640 px” are arranged with the same order rank.

Therefore, the evaluation points of the constituent elements with the constituent element ID “C-002” and the constituent element ID “C-004”, which have the largest order rank, are both “0.1”. The evaluation point of the constituent element with the constituent element ID “C-007” which has the order rank less by 1 is “0.2”, and the evaluation point of the constituent element with the constituent element ID “C-009” which has the order rank further less by 1 is “0.3”.

In this case, when the constituent elements with equal evaluation points are present, an additional ranking may be performed, for example, by orderly displaying the constituent elements from the constituent element with a smallest value of the character string of the constituent element ID. In the present example, the constituent elements with the constituent element ID “C-002” and “C-004” have the same evaluation point “0.1”, but the value of the character string of the constituent element ID “C-002” is less than that of the constituent element ID “C-004”. Therefore, the display order of the constituent element with the constituent element ID “C-002” is less than that of the constituent element with the constituent element ID “C-004”. Further, the constituent elements of the query Web page are displayed in the descending display order of the evaluation point.

Therefore, the following final display order is obtained: the constituent element with the constituent element ID “C-009”, then the constituent element with the constituent element ID “C-007”, then the constituent element with the constituent element ID “C-002”, and finally the constituent element with the constituent element ID “C-004”.

This method is effective when the rectangle of the browser 301 extends in the transverse direction and the query Web page is created by arranging the constituent elements to which the query related regions belong in the transverse direction. Therefore, Variation Example 2 may be combined with Variation Example 1.

### Variation Example 3

In the explanation above, the first to fourth methods for determining the display order or a combination thereof are used for determining the display order of the constituent elements of the query Web page. However, those methods for determining the display order are not limiting. For example, the display order of the constituent elements of the query Web page may be determined on the basis of the operation history on the network of the constituent elements to which the query related regions belong.

The browsing history on a network, as referred to herein, is the number of browsing cycles and browsing time of the corresponding constituent elements for all users including the user inputting the query. In this case, the display order of the query Web page decreases for a constituent element to which belongs a query related region that is very interesting for a large number of users.

To realize such a display order, the Web page structure analysis unit 102 may acquire the browsing history of each constituent element and register the browsing history in the Web page text information table T30 when analyzing the structure of the target Web page. For example, in this case, the Web page structure analysis unit 102 may inquire the browsing history of each constituent element from the Web server managing the target Web page serving as the analysis object and acquire the browsing history of each constituent element from the Web server.

The Web page creation unit 104 may use, for example, a computational algorithm according to which the evaluation point is increased for a constituent element with a longer browsing time and a larger number of browsing cycles, assign the evaluation point to each constituent element, and determine the display order of the constituent element in the descending order of the evaluation points. As a result, the user inputting a query can preferentially browse, for example, a constituent element which is very interesting for all of the users.

### Variation Example 4

In Variation Example 3, the display order of the constituent element is determined by the browsing history of all of the users. In Variation Example 4, the display order of the constituent elements is determined by the browsing history of the user inputting a query (referred to hereinbelow as “input user”).

The browsing history of the input user, as referred to herein, is the number of browsing cycles and the browsing time of the corresponding constituent element by the input user. In this case, the display order in the query Web page decreases for a constituent element with a lower number of browsing cycles and a shorter browsing time of the input user.

To realize such a display order, the Web page structure analysis unit 102 may acquire the browsing history of the input user for each constituent element and register the browsing history in the Web page text information table T30 when analyzing the structure of the target Web page. For example, in this case, the Web page structure analysis unit 102 may acquire the browsing history of each constituent element of the target Web page serving as an analysis target from the browser 301.

The Web page creation unit 104 may also use a computational algorithm according to which the evaluation point is increased for a constituent element with a shorter browsing time and a smaller number of browsing cycles of the input user, assign the evaluation point to each constituent element, and determine the display order of the constituent element in the descending order of the evaluation points. As a result, the input user can preferentially browse a constituent element which the input user has not yet browsed. The methods for determining the display order which are described in Variation Examples 2, 3, and 4 may be combined with the above-described first to fourth methods for determining the display order.

### Variation Example 5

In S206, the display position of the constituent elements of the query Web page is calculated on the basis of the “DISPLAY ORDER OF CONSTITUENT ELEMENT” and “DISPLAY HEIGHT OF CONSTITUENT ELEMENT”, but such a procedure is not limiting. For example, the display position of each constituent element of the query Web page may be also calculated on the basis of the “DISPLAY ORDER OF CONSTITUENT ELEMENT” and “DISPLAY WIDTH OF CONSTITUENT ELEMENT”.

Such procedure will be specifically explained hereinbelow with reference to FIG. 6. Initially, a predetermined value, for example, “0 px” is set as the value of the “top” parameter of the “DISPLAY POSITION OF CONSTITUENT ELEMENT” for each constituent element of the Web page. Meanwhile, “0 px” is set as the value of the “left” parameter of the “DISPLAY POSITION OF CONSTITUENT ELEMENT” for the constituent element with the display order of “1”.

Then, the add-up value of the value of the “left” parameter of the “POSITION OF CONSTITUENT ELEMENT” and the value of the “DISPLAY WIDTH OF CONSTITUENT ELEMENT” of the constituent elements with the “DISPLAY ORDER OF CONSTITUENT ELEMENT” less than 1 is set as the value of the “left” parameter of the “DISPLAY POSITION OF CONSTITUENT ELEMENT” for the constituent elements with the display order equal to and greater than 2.

As a result, the constituent elements of the query Web page are arranged in the transverse direction. This method is effective when the rectangle of the browser 301 extends in the transverse direction. Therefore, Variation Example 5 may be combined with Variation Examples 1 and 2. As a result, the display height of each constituent element of the query Web page is fit within the height of the rectangle of the browser 301 in the transverse arrangement of the constituent elements. Therefore, the user can browse the query Web page by inputting, as necessary, the left-right scroll operation, without inputting the up-down scroll operation.

### Variation Example 6

When the size of the rectangle of the browser 301 is changed after the browser 301 has displayed the query Web page, the Web page creation unit 104 changes the display of the query Web page such as to conform to the changed rectangle.

For example, the rectangle of the browser 301 is enlarged or reduced by a factor of x in the vertical correction and by a factor of y in the transverse direction by the user's operation. In this case, the Web page creation unit 104 may change the size of the query Web page by changing the created query Web page by a factor of x in the vertical direction and by a factor of y in the transverse direction and may transmit the resultant query Web page to the terminal device 300.

### Variation Example 7

Where the operation of selecting the query icon 1301 by the user is input in the query Web page depicted in FIG. 13, the Web page creation unit 104 may transmit the target Web page corresponding to the query Web page to the terminal device 300. As a result, the browser 301 switches the screen display from the query Web page to the target Web page.

Further, as a consequence, the user wishing to browse the constituent elements of the target Web page which are not included in the query Web page, while browsing the query Web page, can browse the desired constituent elements by inputting an operation of selecting the query icon 1301. The operation of selecting the query icon 1301 can be, for example, a tap in the case of the terminal device 300 provided with a touch panel or a click in the case of a personal computer in which the terminal device 300 is provided with a pointing device.

### Variation Example 8

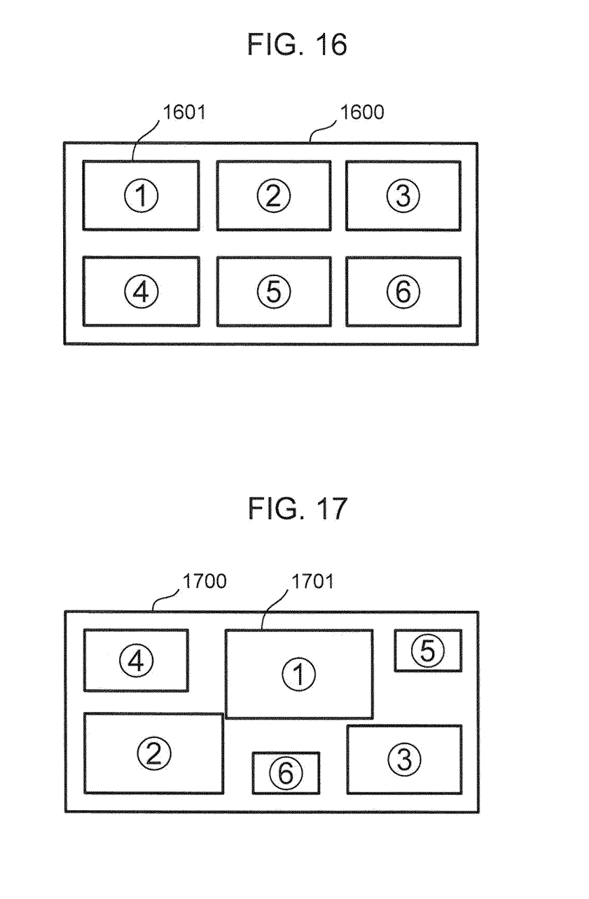

In the explanation above, the Web page creation unit 104 displays the constituent elements of the query Web page in one rectangle. However, this is merely an example, and the Web page creation unit 104 may create one query Web page for each constituent element to which the query related region belongs, and display each constituent element in a different rectangle. FIG. 16 illustrates a display example in which a query Web page is displayed in a plurality of rectangles. A terminal screen 1600 of the terminal device 300 is constituted by a plurality of rectangles 1601. In this example, the rectangles 1601 are arrayed in 2 rows×3 columns configuration. In this case, the Web page creation unit 104 displays a constituent element with a smaller display order in a rectangle closer to the upper left rectangle. Thus, the constituent element with the display order of “1” is displayed in the rectangle 1601 of the first row and first column, the constituent element with the display order of “2” is displayed in the rectangle 1601 of the first row and second column, the constituent element with the display order of “3” is displayed in the rectangle 1601 of the first row and third column, the constituent element with the display order of “4” is displayed in the rectangle 1601 of the second row and first column, the constituent element with the display order of “5” is displayed in the rectangle 1601 of the second row and second column, and the constituent element with the display order of “6” is displayed in the rectangle 1601 of the second row and third column.

Where a plurality of objects of different importance is arranged on a display, a display mode is most often used in which the object of higher importance is displayed closer to the upper left corner. Therefore, the user apparently browses the query Web page with a preconception that the object displayed in the upper left portion is important. Accordingly, in the display example depicted in FIG. 16, this display mode is employed. As a result, it is possible to attract the user's attention to the constituent elements with a small display order.

A rectangle 1601 depicted in FIG. 16 may be the rectangle of one browser 301, or a rectangle with one browser function in the application provided with a plurality of browser functions.

FIG. 17 illustrates another display example in which a query Web page is displayed in a plurality of rectangles. In the example depicted in FIG. 17, a constituent element with a smaller display order is displayed in a larger rectangle 1701. In this case, the Web page creation unit 104, for example, may determine the surface area of the rectangle 1701 according to the aforementioned evaluation point used when determining the display order. Further, the Web page creation unit 104 may create a query Web page for each constituent element to which the query related region belongs and transmit the created query Web page together with information designating the surface area of the rectangle to the terminal device 300.

In FIG. 17, one rectangle 1701 constituting a terminal screen 1700 may be a rectangle of one browser 301 and also may be a rectangle with one browser function in the application provided with a plurality of browser functions.

The terminal device 300 that has received a query Web page for each constituent element may change the surface area of the rectangle 1701 according to the information designating the surface area of the rectangle 1701 and display the query Web page. In this case, the terminal device 300, for example, may dispose the rectangle 1701 with the largest surface area in the center of the terminal screen 1700 and may set the layout of each rectangle 1701 such that the remaining rectangles 1701 are fitted, if possible, into the terminal screen 1700. As a result, the user's attention can be attracted to the constituent element with the small display order.

### Variation Example 9

In the explanation hereinabove, characters are used as a query, but such a configuration is not limiting, and for example a static image and a dynamic image may be used.

FIG. 18 is an overall picture of the information display system in the present disclosure.

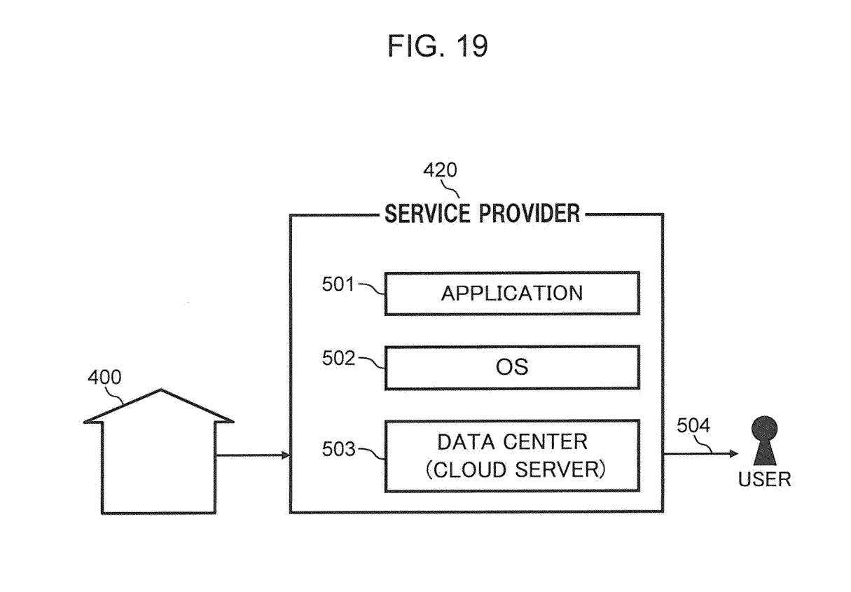

FIG. 19 illustrates Type 1 (own data center type) of services in the present disclosure.

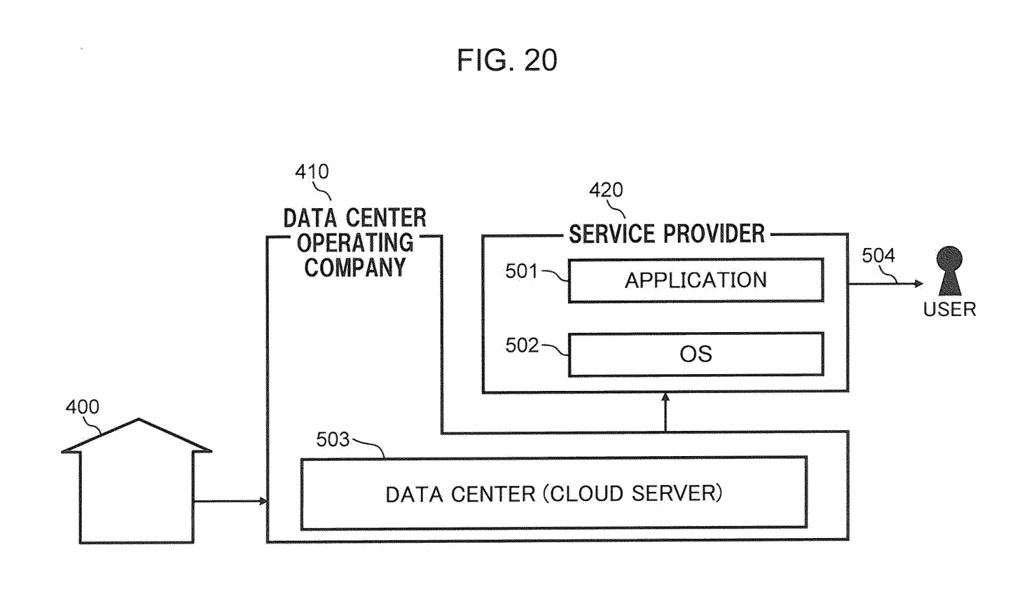

FIG. 20 illustrates Type 2 (IaaS usage type) of services in the present disclosure.

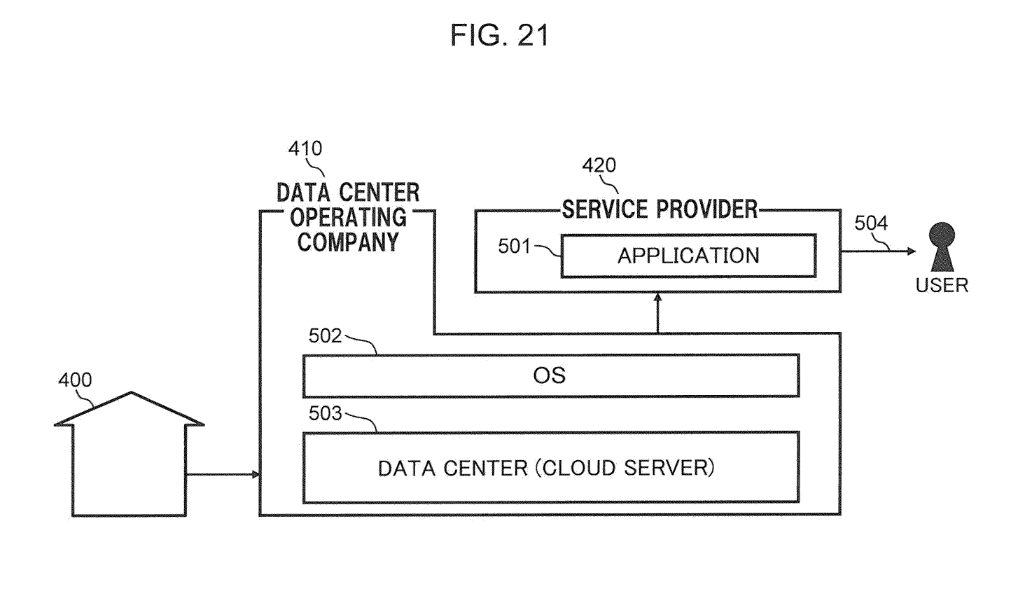

FIG. 21 illustrates Type 3 (PaaS usage type) of services in the present disclosure.

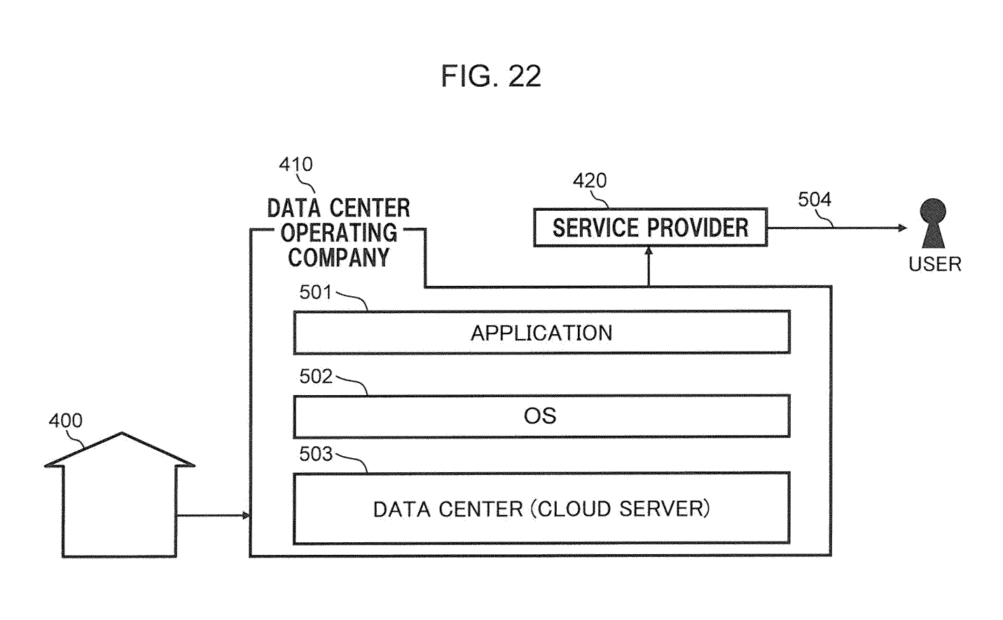

FIG. 22 illustrates Type 4 (SaaS usage type) of services in the present disclosure.

The technique explained in the embodiments can be realized, for example, in the following types of cloud services. However, those types in which the technique explained in the embodiments can be realized are not limiting.

(Service Type 1: Own Data Center Type)

FIG. 19 illustrates Type 1 (own data center type) of services in the present disclosure. With the service of this type, a service provider 420 acquires information from a group 400 and provides services to a user. With the service of this type, the service provider 420 has functions of a data center operating company. Thus, the service provider 420 has a data center 503 (cloud server 411) that manages big data. Therefore, the data center operating company is not present.

With the service of this type, the service provider 420 operates and manages the data center 503 (cloud server 411). The service provider 420 also manages an OS 502 and an application 501. The service provider 420 provides the user with a service 504 by using the OS 502 and the application 501 managed by the service provider 420.

(Service Type 2: IaaS Usage Type)

FIG. 20 illustrates Type 2 (IaaS usage type) of services in the present disclosure. Here, IaaS is an abbreviation of “Infrastructure as a Service” and represents a cloud service provision model in which a foundation for creating and operating a computer system is by itself provided as a service via the Internet.

With the service of this type, the data center operating company 410 operates and manages the data center 503 (cloud server 411). Further, the service provider 420 manages the OS 502 and the application 501. The service provider 420 provides the user with the service 504 by using the OS 502 and the application 501 managed by the service provider 420.

(Service Type 3: PaaS Usage Type)

FIG. 21 illustrates Type 3 (PaaS usage type) of services in the present disclosure. Here, PaaS is an abbreviation of “Platform as a Service” and represents a cloud service provision model in which a platform for creating and operating a computer system is by itself provided as a service via the Internet.

With the service of this type, the data center operating company 410 manages the OS 502 and operates and manages the data center 503 (cloud server 411). Further, the service provider 420 manages the application 501. The service provider 420 provides the user with the service 504 by using the OS 502 managed by the data center operating company 410 and the application 501 managed by the service provider 420.

(Service Type 4: SaaS Usage Type)

FIG. 22 illustrates Type 4 (SaaS usage type) of services in the present disclosure. Here, SaaS is an abbreviation of “Software as a Service” and represents, for example, a cloud service provision model having a function that enables a company or an individual (user) that has no data center (cloud server) to use an application provided by a platform provider that has a data center (cloud server), via a network such as the Internet.

With the service of this type, the data center operating company 410 manages the application 501, manages the OS 502, and operates and the data center 503 (cloud server 411). The service provider 420 provides the user with the service 504 by using the OS 502 and the application 501 managed by the data center operating company 410.

In any of the above-describes types, the service provider 420 performs a service providing operation. Further, for example, the service provider or data center operating company may by itself develop the OS, application, big data database or the like, or may outsource the development to a third party.

### INDUSTRIAL APPLICABILITY

The present disclosure can be used, for example, in products such as personal computers, video recorders, BD recorders, home servers, televisions, set-top boxes, car navigation systems, digital photo frames, digital still cameras, music players, and mobile terminals (for example, cellular phones, smartphones, and tablet terminals) that can browse Web pages, and also for services using Web page information.

1-17. (canceled)

18. An information display method for an information display system that displays a Web page on a terminal device, comprising:
a query information acquisition step for acquiring query information including a query input by a user, and rectangle information indicating a size of a rectangle of a terminal screen of the terminal device for displaying the Web page;
a Web page structure analysis step for analyzing a structure of a target Web page which is a display target of the terminal device;
a query related region determination step for determining a query related region which relates to the query information in the target Web page on the basis of the query information and an analysis result for the target Web page;
a Web page creation step for adjusting the query related region on the basis of the rectangle information, and creating a query Web page by using the adjusted query related region; and
a transmission step for transmitting the query Web page to the terminal device via a network.

19. The information display method according to claim 18, wherein
the rectangle information is information relating to a width and a height of a rectangle for displaying a Web page on the terminal screen.

20. The information display method according to claim 19, wherein
the structure of the target Web page includes information relating to a size of the target Web page, information relating to constituent elements of the target Web page, and information relating to query information included in the constituent elements.

21. The information display method according to claim 20, wherein
in the query related region determination step, the query related region is determined on the basis of at least one of information among information relating to the number of types of query information included in the constituent elements of the target Web page, and information relating to an appearance position of the query information.

22. The information display method according to claim 21, wherein
in the Web page creation step, a display width and a display height of the constituent elements in the query Web page are determined using a ratio of a width of the rectangle to a maximum value of a width of a constituent element to which the query related region belongs in the target Web page.

23. The information display method according to claim 21, wherein
in the Web page creation step, a display order of the constituent elements on the query Web page is determined on the basis of at least any one condition from among:
a first condition that the display order on the query Web page is decreased for a constituent element to which the query related region belongs and which has a larger display width and a smaller display height in the query Web page;
a second condition that the display order on the query Web page is decreased for a constituent element to which the query related region belongs and which has a smaller appearance order on the target Web page;
a third condition that the display order on the query Web page is determined according to a type of the constituent element to which the query related region belongs; and
a fourth condition that the display order on the query Web page is decreased for a constituent element to which the query related region belongs and which has a larger number of types of the query information.

24. The information display method according to claim 23, wherein
in the Web page creation step, a display position of the constituent elements in the query Web page is calculated on the basis of the display order and display height of the constituent elements in the query Web page.

25. The information display method according to claim 24, wherein
in the Web page creation step, style information that defines a display layout of the constituent elements of the target Web page is processed on the basis of the display width and display height and the calculated display position of the constituent elements in the query Web page.

26. The information display method according to claim 25, wherein
in the Web page creation step, the query Web page is created by adjusting the query related region on the basis of the display order of the constituent elements on the query Web page, the processed style information, and predetermined HTML text information of the target Web page.

27. The information display method according to claim 24, wherein
in the Web page creation step, a display image indicating the position and size of the constituent elements of the query Web page in the target Web page is created on the basis of the size of the target Web page and the display position, width, and height of the constituent elements of the query Web page in the target Web page.

28. The information display method according to claim 27, wherein
in the Web page creation step, the display image is combined together with the query Web page.

29. The information display method according to claim 21, wherein
in the Web page creation step, a display width and a display height of the constituent elements in the query Web page are determined using a ratio of a height of the rectangle to a maximum value of the height of the constituent element to which the query related region belongs in the target Web page.

30. The information display method according to claim 29, wherein
in the Web page creation step, a display position of the constituent elements in the query Web page is calculated on the basis of a display order and the display width of the constituent elements in the query Web page.

31. The information display method according to claim 23, wherein
in the Web page creation step, the display order of the constituent elements on the query Web page is determined on the basis of, in addition to the first to fourth conditions, at least any one condition from among:
a fifth condition that the display order on the query Web page is decreased for a constituent element to which the query related region belongs and which has a smaller display width and a larger display height;
a sixth condition that the display order on the query Web page is determined according to a browsing history on a network of a constituent element to which the query related information belongs; and
a seventh condition that the display order on the query Web page is determined according to a browsing history of a user who has input the query of a constituent element to which the query related information belongs.

32. The information display method according to claim 18, wherein
in the Web page creation step, when a change in the size of the rectangle is detected, a size of the query Web page is changed according to the size of the rectangle after the change.

33. The information display method according to claim 28, wherein
in the Web page creation step, the target Web page is displayed on the terminal screen when an input selecting the display image is detected.

34. A non-transitory computer-readable recording medium which stores a program causing a computer to function as an information display control device that displays a Web page on a terminal device,
the program causing the computer to:
acquire query information including a query input by a user, and rectangle information indicating a size of a rectangle of a terminal screen of the terminal device for displaying the Web page;
analyze a structure of a target Web page which is a display target of the terminal device;
determine a query related region which relates to the query information in the target Web page on the basis of the query information and an analysis result for the target Web page;
adjust the query related region on the basis of the rectangle information, and create a query Web page by using the adjusted query related region; and
transmit the query Web page to the terminal device via a network.
